(19) United States
(12) Patent Application Publication
(10) Pub. No.: US 2011/0213566 A1
(43) Pub. Date: Sep. 1, 2011

(54) Method Of And System For Blind Extraction Of More Than Two Pure Components Out Of Spectroscopic Or Spectrometric Measurements Of Only Two Mixtures By Means Of Sparse Component Analysis

(76) Inventors: Ivica Kopriva, Zagreb (HR); Ivanka Jeric, Zagreb (HR); Vilko Smrecki, Zagreb (HR)

(21) Appl. No.: 13/090,629

(22) Filed: Apr. 20, 2011

Related U.S. Application Data
(63) Continuation of application No. PCT/HR2008/000037, filed on Nov. 24, 2008.

(51) Int. Cl. G06F 19/00

(52) U.S. Cl. 702/28

(57) ABSTRACT

A method, system, and computer program product for identification of more than two pure components from two mixtures using sparse component analysis. Spectroscopic data for two mixtures X are analyzed in a recording domain or in a first new representation domain by using linear transform T₁, wherein pure components in the first new representation domain are sparser than in the recording domain. The number of pure components and mixing matrix are estimated by means of a data clustering algorithm. The pure components are estimated by means of linear programming, convex programming with quadratic constraint (l₂-norm based constraint) or quadratic programming method with l₁-norm based constraint. The estimated pure components are ranked using negentropy based criterion.

### CROSS-REFERENCE TO RELATED APPLICATIONS

The present application is a continuation of pending International patent application PCT/HR2008/000037 filed on Nov. 24, 2008 which designates the United States, and the content of which is incorporated herein by reference.

### FIELD OF THE INVENTION

The present invention generally relates to a computer-implemented system for processing data for the purpose of identification by blind extraction of pure components from the mixtures recorded in the fields of spectroscopy and spectrometry. Specifically, the invention relates to the application of the method of sparse component analysis (SCA), also known as underdetermined blind source separation (uBSS), to blind decomposition of two spectroscopic data (also called mixtures) into more than two pure components. Spectroscopic data refers to data gathered by nuclear magnetic resonance (NMR) spectroscopy, electron paramagnetic resonance (EPR) spectroscopy, infrared (IR) spectroscopy, ultraviolet (UV) spectroscopy, Raman spectroscopy or mass spectrometry. Identified pure components are used for identification of the compounds in chemical synthesis, food quality control, environment protection etc.

### BACKGROUND OF THE INVENTION

In a number of applications it is of interest to identify pure chemical compounds from the collections of their linear combinations also called mixtures. Quantification and identification of the components present in the mixture is a traditional problem in NMR, IR, UV, EPR and Raman spectroscopy, mass spectrometry, etc. Identification of the spectra of mixtures proceeds in majority of the cases by matching the mixture's spectra with a library of reference compounds. This approach is ineffective with the accuracy strongly dependent on the library's content of the pure component spectra. In addition to that, for a number of new chemical compounds synthesized for proteomics and metabolomics related studies there is no library of pure components available yet.

As opposed to the previous library-based approach it has been repeatedly demonstrated over the last ten years the possibility to separate mixture's spectra into pure component spectra employing the methodology known as blind source separation (BSS) that uses only the measurements of the mixture's spectra. Two widely spread methods in this domain are independent component analysis (ICA) and nonnegative matrix factorization (NMF). ICA belongs to group of statistical methods for solving blind linear inverse problems. Assumptions upon which the ICA algorithms are built are that unknown pure components are statistically independent and non-Gaussian, as well as that the number of linearly independent mixtures is greater than or equal to the number of pure components. NMF belongs to the group of algebraic methods for solving linear inverse problems. It also requires that the number of linearly independent mixtures is greater than or equal to the number of pure components as well as that pure components are nonnegative and sparse. Normegativity requirement and sparseness requirement are not satisfied simultaneously in a majority of spectroscopic applications. The general principle of blind extraction of pure components employing the BSS approach is schematically shown in FIG. 1 that will be discussed below.

One of the most known ICA algorithms is described in the U.S. Pat. No. 5,706,402 (B2), patent application WO 9617309 (A), as well as in the paper: A. J. Bell and T. J. Sejnowski. An information-maximization approach to blind separation and blind deconvolution. Neural Computation; vol. 7, pp. 1129-1159, 1995. Reference literature for the field of blind source separation and independent component analysis are: A. Hyvärinen, J. Karhunen, E. Oja. Independent Component Analysis, John Wiley, 2001; A. Cichocki, S. Amari. Adaptive Blind Signal and Image Processing, John Wiley, 2002.

We point out here that the two assumptions made by standard BSS methods: (i) the number of linearly independent mixtures is greater or equal to the unknown number of pure components; (ii) the pure components are statistically independent, are not easily and always met in real world applications in spectroscopy and spectrometry. The first assumption implies that concentrations of the pure components in different mixtures are different. This is not always easy to meet in practice. Therefore a methodology for blind decomposition of pure components from as few mixtures as possible is of great practical importance. The second assumption implies a small level of overlapping between the pure components. This is known not to be the case in a number of occasions. Few examples include 1H NMR spectroscopy, EPR spectroscopy, UV and IR spectroscopy.

### SUMMARY OF THE INVENTION

As described below in paragraphs, [0008]-[0013], BSS methods, mostly ICA, are used to extract pure components from the plurality of the spectroscopic or spectrometric signals. In a number of occasions it is emphasized that statistical independence among the pure components is not a correct assumption in spectroscopy and spectrometry. What is in common to the BSS methods to be elaborated is that number of linearly independent mixtures is required to be greater than or equal to the unknown number of pure components.

Review of application of ICA in signal processing for analytical chemistry is given in: G. Wang, Q. Ding, Z. Hou, “Independent component analysis and its applications in signal processing for analytical chemistry,” Trends in Analytical Chemistry, vol. 27, No. 4, 368-376, 2008.

The BSS based approach to blind decomposition of the NMR spectra is presented in: D. Nuzillard, S. Bourg and J.-M. Nuzillard, “Model-Free Analysis of Mixtures by NMR Using Blind Source Separation,” Journal of Magnetic Resonance 133, 358-363, 1998; D. Nuzillard, J.-M. Nuzzilard, “Application of Blind Source Separation to 1-D and 2-D Nuclear Magnetic Resonance Spectroscopy,” IEEE Signal Processing Letters, vol. 5, No. 8, 209-211, 1998; K. Stadlthanner, et al. “Separation of water artifacts in 2D NOESY protein spectra using congruent matrix pencil,” Neurocomputing 69, 497-522, 2006. Employed BSS methodologies assumes: (i) that the number of linearly independent mixtures is greater or equal to the unknown number of pure components; (ii) the pure components are statistically independent. Statistical independence assumption has been relaxed in: W. Naanaa, J.-M. Nuzzilard, “Blind source separation of positive and partially correlated data,” Signal Processing 85, 1711-1722, 2005. However it is still required that the number of linearly independent mixtures is greater than or equal to the unknown number of pure components.

The use of ICA and mean filed ICA in blind decomposition of the signals in gas chromatography-mass spectrometry (GC-MS) is elaborated respectively in: X. Shao, G. Wang, S. Wang, Q. Su, “Extraction of Mass-Spectra and Chromatographic Profiles from Overlapping GC/MS Signal with Background,” Analytical Chemistry 76, 5143-5148, 2004; G. Wang, W. Cai, X. Shao, “A primary study on resolution of overlapping GC-MS signal using mean-field approach independent component analysis,” Chemometrics and Intelligent Laboratory Systems 82, 137-144, 2006. The later reference elaborates a method for blind decomposition of statistically dependent spectrometric signals. However, it is still required that the number of linearly independent mixtures is greater than or equal to the unknown number of pure components.

Blind decomposition of the EPR mixture spectra is introduced in: J. Y. Ren, et al., “Free radical EPR spectroscopy analysis using blind source separation,” Journal of Magnetic Resonance 166, 82-91, 2004. The standard ICA algorithm (FastICA) has been applied for blind separation of the EPR spectra. In the following reference it has been however realized that pure components in EPR spectroscopy are not statistically independent as well as that EPR spectra are sparse: C. Chang et al., “Novel sparse component analysis approach to free radical EPR spectra decomposition,” Journal of Magnetic Resonance 175, 242-255, 2005. Sparseness has been used to cope with statistical dependence problem among the pure components and novel contrast function that measures sparseness of the EPR spectra is proposed in this reference. However, the number of mixtures is still required to be greater than or equal to the number of pure components.

The use of latent variable analysis, specifically non-negative ICA, for blind decomposition of Raman spectra is elaborated in: V. A. Shashilov et al., “Latent variable analysis of Raman spectra for structural characterization of proteins,” Journal of Quantitative Spectroscopy & Radiative Transfer 102, 46-61, 2006. Non-negative ICA took into account non-negativity of the variables in the assumed linear mixture model but still the number of mixtures was required to be greater or equal to the unknown number of pure components.

ICA has been applied to IR spectral data analysis in: J. Chen, X. Z. Wang, “A New Approach to Near-Infrared Spectral Data Analysis Using Independent Component Analysis,” J. Chem. Inf. Comput. Sci. 41, 992-1001, 2001. It is however known that pure components in the spectral domain are statistically dependent: J. M. P. Nascimento, J. M. Bioucas Dias, “Does Independent Component Analysis Play a Role in Unmixing Hyperspectral Data?,” IEEE Transactions on Geoscience and Remote Sensing 43, 175-187, 2005. Because statistical independence among the pure components is the obligated condition for the ICA to work, the ICA approach to IR spectra decomposition has limited accuracy. In addition to that, the number of spectral measurements (mixtures) is still required to be greater than or equal to the unknown number of pure components.

Paragraphs [0015]-[0032] discuss patents and patent applications related to BSS concepts that fall into two categories: those that are claimed for applications in spectroscopy and spectrometry and those that solve the BSS problem using two mixtures only. The methods of the first category still require the number of mixtures to be greater than or equal to the number of pure components. The methods of the second category are based on assumptions made on the structure of the source signals that are specific to application domain (voice signals) what disables their applicability in the fields of spectroscopy and spectrometry.

The US patent application 20040111220 “Methods of decomposing complex data” presents a method for blind decomposition of the mixture matrix that is a statistically based data mining technique. It claims applications in spectroscopy, spectrometry, genomics, proteomics, etc. It however requires the number of mixtures to be greater than the number of the unknown components. This is evident at the first stage of the algorithm where principal component analysis (PCA) is used to remove outlier and noisy components from data. This is done by inspecting eigenvalues of the data covariance matrix wherein the overall number of eigenvalues equals the number of mixtures. Thus, this method can not work when number of mixtures is smaller than number of pure components.

The US patent application 20070252597 “Magnetic resonance spectroscopy with sparse spectral sampling and interleaved dynamic shimming” is related to 4D (three spatial and one spectral dimension) magnetic resonance spectroscopy and is characterized by sparse sampling across spectral dimension. Here sparseness of the components is a consequence of the multidimensionality of the data, i.e. sensing device.

The patent application WO2007138544 “Coding and decoding: seismic data modelling, acquisition and processing” presents a method for blind decomposition of seismic data. In said application uBSS problem is converted to determined problem generating new equations by means of higher order statistics. This is however specific for the seismic data processing domain only.

The patent application CN1932849 “Initial method for image independent component analysis” exploits sparseness of the data in wavelet domain in order to obtain more accurate estimate of the mixing matrix. The estimate of the mixing matrix is then used as the initial condition for standard ICA algorithms. Thus, said application is essentially related to even- or over-determined BSS problems that require the number of mixtures to be greater than or equal to the number of pure components.

The patent application WO2007112597 “Blind extraction of pure component mass spectra from overlapping mass spectrometric peaks” is related to blind extraction of the pure components from recorded multicomponent gas chromatography-mass spectrometric signals (mixtures) by means of entropy minimization approach. It also estimates the unknown number of the pure components based on the ranking of the singular values of the sample data covariance matrix and discarding the small singular values that are attributed to chemical noise. Thus, said application ultimately requires the number of mixtures to be greater than the unknown number of pure components.

The U.S. Pat. No. 7,295,972 “Method and apparatus for blind source separation using two sensors” is related to a novel algorithm for blind extraction of multiple source signals from two mixtures only. The method transforms mixtures into frequency domain and employs the strategy that is similar to famous DUET algorithm (Blind Separation of Disjoint Orthogonal Signals: Demixing n sources from 2 mixtures, by A. Jourjine, S. Rickard, and 0. Yilmaz, in Proc. Int. Conf. on Acoust., Speech, Signal Processing, 2000, vol. 5, pp. 2985-2988) where specific assumption on disjoint orthogonality is made. The requirement of this assumption is that only one source signals exist at the point in the time-frequency plane. This assumption is very restrictive and seems to be approximately true for the voice signals only. Thus said method is not applicable to the field of spectroscopy and spectrometry where pure components exist simultaneously in time and frequency (few examples include ¹H NMR and EPR signals).

The U.S. Pat. No. 7,280,943 “Systems and methods for separating multiple sources using directional filtering,” is related to semi-blind extraction of multiple source signals from one or more received signals. The method is semi-blind because it assumes that each source signals can be represented by a set of known basis functions and directional filters that incorporate prior knowledge on the type of the sources and their directions of arrival. The last assumption surely does not hold when spectroscopy and spectrometry are considered as application domains. This is because the signals arising in spectroscopy and spectrometry do not have spatial structure, i.e. there are no distinct spatial locations to which the pure component signals can be associated and there are no distinct spatial locations of the receiving sensors (the multiple mixtures are acquired over different time slots or different wavelengths).

The U.S. Pat. No. 7,010,514 “Blind signal separation system and method, blind signal separation program and recording medium thereof” presents a solution of the BSS problems, including uBSS problem, using probabilistic approach known as maximum likelihood (M. S. Lewicki et. al., “Learning Overcomplete Representations,” Neural Computation, vol. 12, pp. 337-365, 2000.). It is assumed in the patent that the number of sources (also called pure components) is known. This is a first significant limitation of said patent. Probabilistic maximum likelihood approach implies that prior distribution of the unknown pure components is known in order to obtain the learning equation for the unknown mixing matrix. Because related uBSS problem can be solved only if sources have proper degree of sparseness this implies that problem must be transformed into the basis with enough degree of sparseness. Then, in order to obtain mathematically tractable learning rule for the mixing matrix, the Laplacian distribution is assumed for the prior distribution of the sources in the given basis. This is a second significant limitation of said patent. In practice we can not dictate distribution of the sources in the chosen basis because the number of available bases is limited and most frequently used basis, such as Fourier or wavelet basis, do not represent all types of signals with the same degree of sparseness. Therefore assumed Laplacian distribution of the sources will in reality deviate from the true distribution and this will be the source of errors in estimation of the mixing matrix.

The U.S. Pat. No. 6,944,579 “Online blind source separation,” aims to extract multiple source signals from two mixtures only. The method transforms mixtures into time-frequency domain and employs the strategy of the algorithm published in: Blind Separation of Disjoint Orthogonal Signals: Demixing n sources from 2 mixtures, by A. Jourjine, S. Rickard, and 0. Yilmaz, in Proc. Int. Conf. on Acoust., Speech, Signal Processing, 2000, vol. 5, pp. 2985-2988. The specific request of patented algorithm is that source signals are disjointly orthogonal in time-frequency plane. It is empirically known that this assumption is fulfilled for the voice signals. However, there is no rational to believe that it will be fulfilled for arbitrary type of signals such as for example those that arise in the fields of spectroscopy or spectrometry. The reason is that pure components residing in the spectroscopic mixture signals are active simultaneously in time and frequency. Hence, said method is not applicable to the fields of spectroscopy or spectrometry.

The U.S. Pat. No. 6,577,966 “Optimal ratio estimator for multisensor system,” aims to extract multiple source signals from two mixtures only. Separation method based on optimal ratio estimation is possible provided that source signals do not overlap in time-frequency domain. As already commented this assumption approximately holds for the voice-type of signals and the purpose of said method is separation of multiple voice signals from two-microphone recordings. As already discussed in the previous paragraph it is not realistic to expect for arbitrary type of signals, such as those arising for example in the fields of spectroscopy of spectrometry, not to overlap in time-frequency plane. The reason is that pure components residing in the spectroscopic mixture signals are active simultaneously in time and frequency. Hence, said method is not applicable to the fields of spectroscopy or spectrometry.

The US Patent Application 20070257840 “Enhancement Techniques for Blind Source Separation,” is related to improving performance of the BSS algorithms for separation of audio signals from two microphone recordings. Decorrelation based pre- and post-filtering (least means square filtering) is applied to the first and second microphone signals for the enhancement purpose. The method assumes that a first microphone is in the proximity of a first source signal and a second microphone is in the proximity of a second source signal. In this sense the known method is very limited and can not be applied to the field of spectroscopy and spectrometry where mixtures are obtained over time or wavelength (there is no plurality of the physical sensors) and more than two sources (pure components) exist.

The US patent application 20060064299 “Device and method for analyzing an information signal,” is related to extraction of multiple audio signals from single mixture. The method splits the mixture into plurality of component signals and finds information content of each component signal based on calculation of their features; wherein feature is defined so that it is correlated with two source signals in two different subspaces. The features are audio signal specific and that is what limits this patent application to separate audio signals only. Hence, the algorithm presented in cited patent application is not applicable to the type of signals that arise in the fields of spectroscopy and spectrometry.

The US patent application 20060058983 “Signal separation method, signal separation device, signal separation program and recording medium,” presents a signal separation algorithm capable to separate multiple source signals from multiple mixtures wherein the number of sources can be greater than the number of mixtures. The algorithm relies on standard concept when dealing with uBSS problems: transforming mixtures into frequency domain, performing data clustering to estimate number of sources and performing frequency domain ICA at those frequencies where two or more sources are active. Thus, the algorithm in cited patent applications has the following deficiencies: (i) the number of sensors must be greater than two if more than two sources are active at the same frequency; (ii) in relation to comment (i) Fourier basis (frequency domain), that is used by the cited application, is not optimal for the type of signals that arise in spectroscopy.

The US patent application 20050032231 “Identifying component groups with independent component analysis,” presents ICA based solution for blind decomposition of multivariate spectrometric data. The solution of the cited application has the following deficiencies: (i) because the blind decomposition problem is solved by ICA the number of mixtures must be greater than or equal to the unknown number of pure components; (ii) because ICA is used to solve blind decomposition problem pure component must be statistically independent what is known not to be generally true for pure components arising in spectrometry: G. Wang et. al., “A primary study on resolution of overlapping GC-MS signal using mean-field approach independent component analysis,” Chemometrics and Intelligent Laboratory Systems 82, 137-144, 2006; W. Naanaa, J.-M. Nuzzilard, “Blind source separation of positive and partially correlated data,” Signal Processing 85, 1711-1722, 2005. Hence, the algorithm presented in cited application can not separate more than two spectroscopic signals that are statistically dependent using two mixtures only.

The US patent application 20030088384 “Chemical substance classification apparatus, chemical substance classification method, and program” presents an ICA based solution for blind decomposition of multivariate chemical substance data. The same comments apply as in relation to the previously cited US patent application 20050032231.

The patent application WO2008076680 (US2008147763) “Method and Apparatus for Using State Space Differential Geometry to Perform Nonlinear Blind Source Separation,” presents quite general state space differential geometry based approach to nonlinear blind source separation. The set of application domains covered by claims is quite wide. The main assumption of the algorithm proposed in the cited application is that the number of mixtures that contain possibly nonlinear combinations of the pure component signals is greater than or equal to the number of pure components as well as that pure component signals are statistically independent. Hence, algorithm presented in the cited application can not separate more than two spectroscopic signals that are statistically dependent using two mixtures only.

The patent application WO2007103037 (US2007004966) “System and Method for Generate a Separated Signal,” applies a concept of independent vector analysis to separate multiple source signals from multiple mixtures whereas the number of mixtures must be greater than or equal to the number of source signals. Hence, the algorithm presented in the cited application can not separate more than two spectroscopic signals using two mixtures.

The patent application US2006256978 “Sparse signal mixing model and application to noisy blind source separation,” presents an algorithm for blind extraction of two or more signals from two mixtures only by transforming measured signals into time-frequency domain. The fundamental assumption made on the two source signals is that they are disjointly orthogonal, i.e. that at each time-frequency location only one source signal exists. This assumption is quite restrictive and even in the cited application it is stated that it approximately holds for voice signals only. The known method will not work in the case of spectroscopic signals because the pure components are simultaneously active in time and frequency.

Accordingly, it is the aim of the present invention to provide a method and system for blind extraction of more than two pure components that requires measurement of two mixtures only in spectroscopy and spectrometry.

This aim is achieved by a method of blind extraction of more than two pure components out of spectroscopic or spectrometric measurements of only two mixtures by means of sparse component analysis, characterised in that said blind extraction comprises the following steps:

recording two mixtures data X wherein a recording domain of the two mixtures data is defined by equation [I]:

X=AS [I]

where S is an unknown matrix of pure components and A is an unknown mixing or concentration matrix,

storing the recorded two mixtures data,

transforming the two mixtures data X into a first new representation domain by using linear transform T₁, wherein the transformed mixtures T₁(X) are represented by equation [II]:

T₁(X)=AT₁(S) [II]

and pure components in the first new representation domain defined by equation [II] are sparser than in recording domain defined by equation [I],

estimating the number of pure components S and the mixing or concentration matrix A in the first new representation domain defined by equation [II] by means of a data clustering algorithm,

provided that the results presentation domain is the recording domain of the two mixtures data, estimating the mixing or concentration matrix A and the number of the pure components T₁(S) in the first new representation domain by means of linear programming, constrained convex programming or constrained quadratic programming, inverse transforming the estimated pure components T₁(S) from the first new representation domain defined by equation [II] to the recording domain defined by equation [I] by applying the inverse of the transform T₁ according to equation [IV]:

S=T₁⁻¹(T₁(S)) [IV]

provided that the results presentation domain is the second new representation domain defined by equation [III], transforming the mixtures data from the recording domain defined by equation [I] to the second new representation domain by using linear transform T₂, wherein the transformed mixtures T₂(X) are represented by equation [III]:

T₂(X)=AT₂(S) [III]

and pure components in the second new representation domain defined by equation [III] are sparser than in recording domain defined by equation [I],

estimating the pure components in the second new representation domain defined by equation [III] by means of linear programming, constrained convex programming or constrained quadratic programming,

selecting the estimated pure components in accordance with the negentropy-based raking criteria, and

presenting the selected pure components.

Further, this aim is achieved by a system for blind extraction of more than two pure components out of spectroscopic or spectrometric measurements of only two mixtures by means of sparse component analysis, comprising: a mixtures sensing device (1) for recording mixtures data X, an input storing device or medium (2) for storing the mixture data X recorded by the mixtures sensing device (1), a processor (3), wherein code is implemented or carried out for executing a method, according to any one of the claims 1 to 9 based on the mixtures data X stored in/on the input storing device or medium (2), an output storing device or medium (4) for storing the result of the method carried out by the processor.

According to a preferred embodiment of the method, the linear transform T₁ is a wavelet transform with either Morlet or Mexican hat wavelet.

Furthermore or alternatively, the linear transform T₂ can be a Fourier transform.

Preferably, the data clustering algorithm is of the type capable to simultaneously estimate the mixing matrix and the number of pure components in the first new representation domain.

Advantageously, a numerical method is used to estimate the pure components in the second new representation domain that is a linear programming method, a convex programming method with quadratic constraint (l₂-norm based constraint) or a quadratic programming method with l₁-norm based constraint.

According to further preferred embodiment, a linear transform T₁ is a wavelet transform with the second to eight order Daubechies wavelets or symlets or coiflets of the order one to five.

In particular, the data clustering algorithm is of the type capable to simultaneously estimate the mixing matrix and the number of pure components in the first new representation domain.

Furthermore, a numerical method can be used to estimate the pure components in the first new representation domain that is a linear programming methods, a convex programming method with quadratic constraint (l₂-norm based constraint) or a quadratic programming method with l₁-norm based constraint.

Advantageously, a computer-readable medium having computer-executable instructions stored thereon which, when executed by a computer, will cause the computer to carry out a method of the present invention.

Preferably, said method is applied to the identification of the chemical compounds in chemical synthesis, food quality inspection or pollution inspection i.e. environment protection.

In a preferred embodiment of the system, the output storing device can be a printer or plotter and the output storing medium can be a memory base device that is computer-readable.

Finally, a preferred embodiment, the mixtures sensing device is a nuclear magnetic resonance (NMR) spectrometer, ultraviolet spectrometer, IR spectrometer, electron paramagnetic resonance spectrometer, Raman spectrometer or mass spectrometer.

### BRIEF DESCRIPTION OF THE DRAWINGS

A more detailed description of the invention will be given with references to the following figures, in which:

FIG. 1 schematically illustrates a block diagram of a device for blind decomposition of spectroscopic or spectrometric data into more than two pure components using two mixtures only and employing methodology of sparse component analysis and underdetermined blind source separation according to an embodiment of the present invention;

FIGS. 2A to 2F demonstrate a concept of sparse component analysis by blind extraction of four sinusoid signals with different frequencies from two mixtures;

FIG. 3 shows positions of the three unit length mixing vectors in the coordinate system defined by mixtures x₁ and x₂;

FIGS. 4A and 4B show the real part of a time domain ¹H NMR signal (pure component) and Morlet wavelet at the corresponding scale;

FIG. 5 shows a normalized absolute value of wavelet coefficients vs. scale (resolution levels) and time shifts that are obtained by transforming time domain ¹H NMR data shown in drawing 4A to the scale-time shift domain by means of continuous wavelet transform and Morlet wavelet;

FIGS. 6A-6K demonstrate experimentally blind extraction of three pure components and two outliers from two ¹H NMR mixtures by means of sparse component analysis;

FIGS. 7A-7I demonstrate experimentally blind extraction of three pure components from two ¹³C NMR mixtures by means of sparse component analysis;

FIGS. 8A-8H demonstrate experimentally blind extraction of two pure components and one outlier from two UV mixtures by means of sparse component analysis; and

FIGS. 9A-9I demonstrate experimentally blind extraction of two pure components and one outlier from two IR mixtures by means of sparse component analysis.

### DETAILED DESCRIPTION OF THE INVENTION

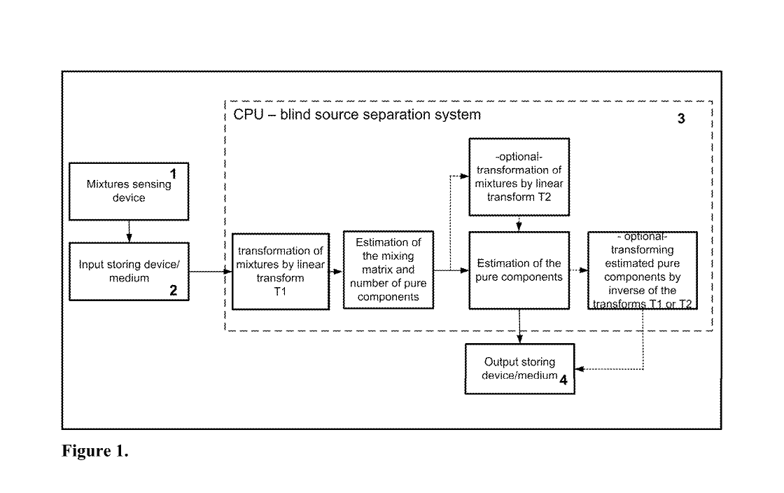

A schematic block diagram of a device for blind decomposition of spectroscopic or spectrometric data into more than two pure components using two mixtures only defined by equation [I] and employing methodology of sparse component analysis and underdetermined blind source separation according to an embodiment of the present invention is shown in FIG. 1. The device consists of: mixtures sensing device 1 used to gather spectroscopic or spectrometric data; storing device 2 used to store gathered spectroscopic or spectrometric data; CPU 3 or computer where algorithms for sparse component analysis and underdetermined blind source separation are implemented for blind extraction of pure components from gathered spectroscopic or spectrometric data; and output device 4 used to store and present extracted pure components.

The procedure for processing gathered and stored spectroscopic or spectrometric mixture data with the aim to blindly extract pure components is implemented in the software or firmware in the CPU 3 and according to an embodiment of the present invention consists of the following steps: two recorded mixtures defined by equation [I] are transformed by linear transform T₁ into the first new representation domain defined by equation [II] with the aim to increase sparseness of the pure components; the transformed mixtures equation [II] are used for estimation of the number of pure components and estimation of the mixing matrix (also called concentration matrix); based on the estimated mixing matrix pure components are estimated by either linear programming, convex programming with constraints or quadratic programming with constrains using two mixtures in the first new representation domain defined by equation [II] or the second new representation domain defined by equation [III] that are obtained by transforming two mixtures from recording domain defined by equation [I] by another linear transform T₂; if the first new representation domain defined by equation [II] in which pure components are estimated is not the domain in which results are presented, estimated components are transformed into recording domain defined by equation [I] by applying on the estimated pure components inverse of the transform T₁, blindly extracted pure components are stored and presented in the final form on the output device or medium 4.

In detail, according to an embodiment of the present invention procedure for extraction of the pure components using sparse component analysis for blind decomposition of the recorded two mixtures of spectroscopic or spectrometric data consists of the following steps:
recording two mixtures data X defined by equation [I] with mixtures sensing device 1, for e.g. nuclear magnetic resonance spectroscopy, infrared spectroscopy, ultraviolet spectroscopy, electron paramagnetic resonance spectroscopy, Raman spectroscopy or mass spectrometry, wherein mixtures are defined as a product of an unknown mixing matrix A (also called concentration matrix) and matrix of the unknown pure components S,
transforming two recorded mixtures data X having an original domain represented by equation [I] into a first new representation domain defined by equation [II] by means of the linear transform T₁, wherein transformed mixtures T₁(X) represented by equation [II] are defined as a product of the mixing matrix A and transformed matrix of the pure components T₁(S),
estimating the mixing matrix A and number of pure components S in the first new representation domain T₁(X) defined by equation [II] by means of a data clustering algorithm,
estimating the pure components T₁(S) in the first new representation domain defined by equation [II] or pure components T₂(S) in the second new representation domain defined by equation [III] (obtained by transforming two recorded mixtures defined by equation [I] by another linear transform T₂) by means of linear programming, convex programming with constraints or quadratic programming with constrains,
provided that the first new representation domain defined by equation [II] is not the domain where final results are presented estimated pure components are transformed into the results presentation domain that coincides with the recording domain defined by equation [I] by applying inverse of the transform T₁ on estimated pure components T₁(S) (see equation [IV]),
selecting estimated pure components of interest in accordance with negentropy-based ranking criteria, and
storing and presenting selected pure components at the chosen output device 4.

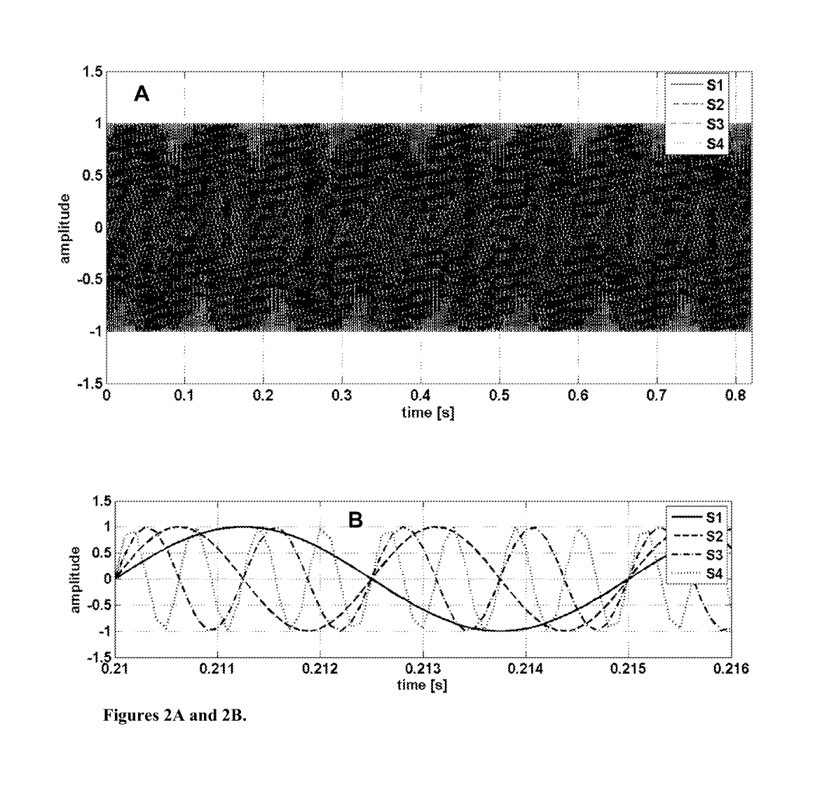

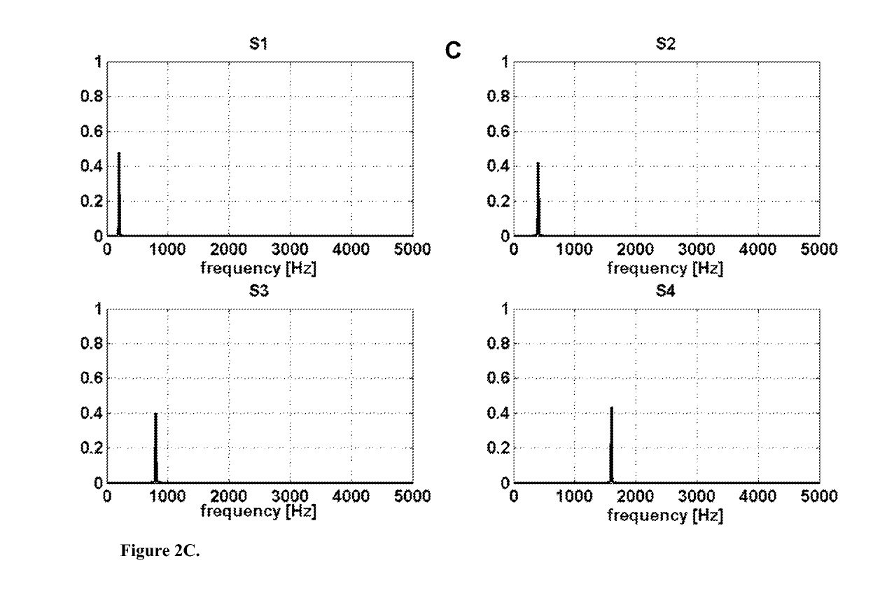

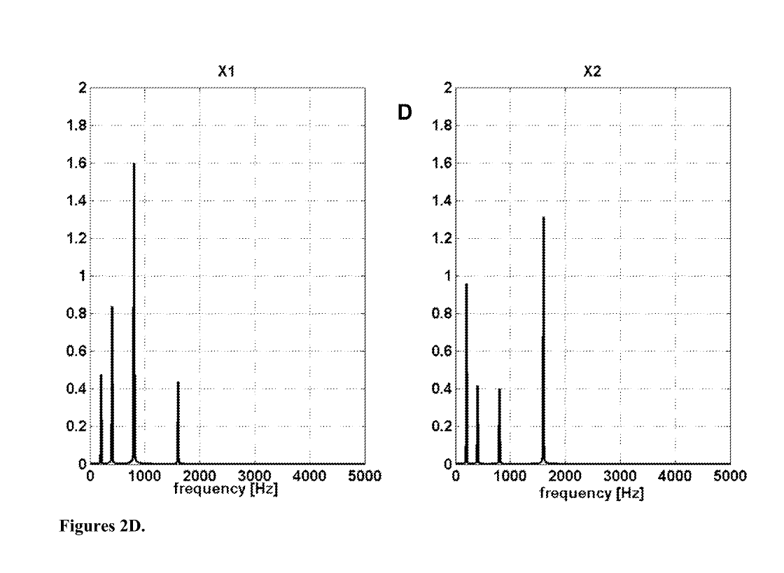

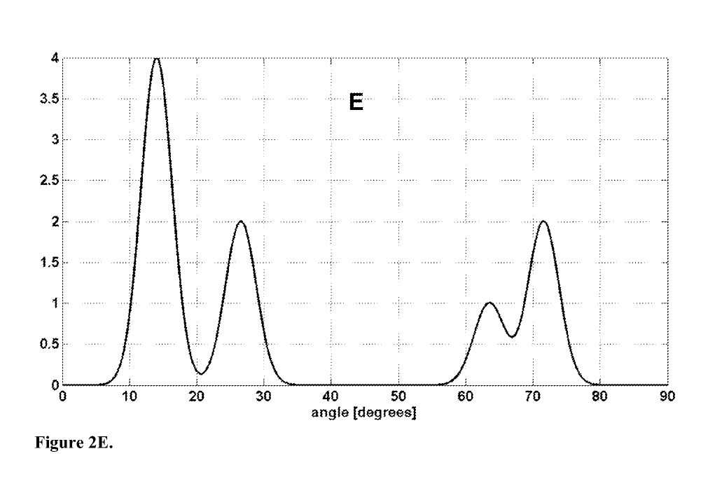

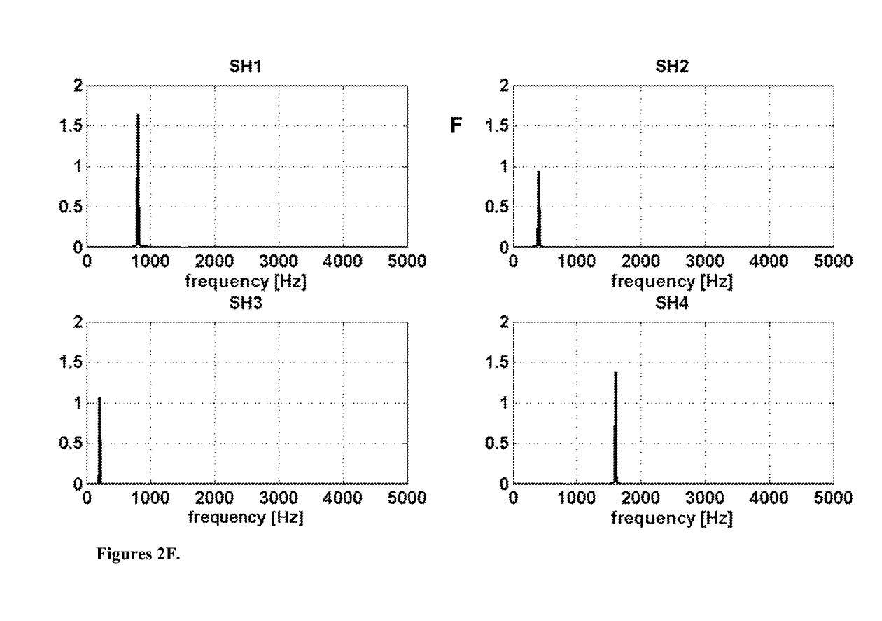

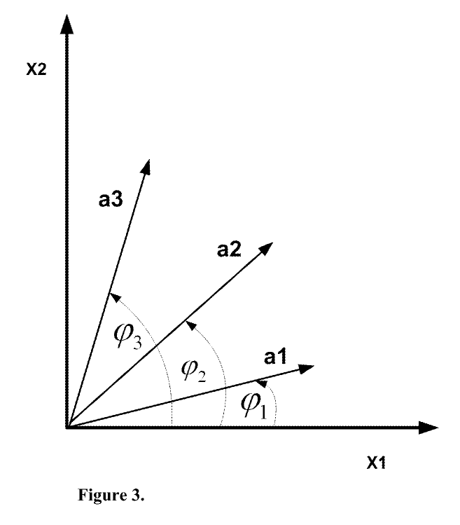

FIGS. 2A to 2F demonstrate the concept of sparse component analysis by blind extraction of four sinusoid signals with different frequencies from two mixtures. The four sinusoid signals, that play the role of pure components, have frequencies of 200 Hz, 400 Hz, 800 Hz and 1600 Hz. FIG. 2A shows four sinusoid signals in time domain on large time scale, while FIG. 2B shows the same four signals in zoomed time interval. The overlap between the time domain pure component signals is evident, especially in FIG. 2A on large time scale. There, instead of being mutually sparse signals are very dense. FIG. 2C shows the same four sinusoid signals in frequency domain. Since pure components occupy different frequencies, they are 3-sparse at each frequency (this is equivalent to m−1 sparseness requirement, wherein m=4), i.e. there is no overlap between pure components in the frequency domain. FIG. 2D shows the amplitude spectrum of the two mixtures obtained by mixing four pure components shown in FIG. 2C with the mixing matrix consisting of the four 2D mixing vectors. The mixing angles, see discussion associated with FIG. 3 in paragraph [0077], in degrees were: [63.44 25.57 14.04 71.57]. FIG. 2E shows clustering function in the mixing angle domain. Four peaks at the approximate locations of the mixing angles are distinguished. The estimates of the mixing angles in degrees were: [63.54 26.55 14.05 71.57]. Thus, the algorithm estimated the existence of the four pure components in the mixtures. FIG. 2F shows the amplitude spectrum of the estimated four pure components. Similarity with the true pure components, the amplitude spectrum of which is shown in FIG. 2C, is evident. Note that in this case the first new representation domain defined by equation [II] and the second new representation domain defined by equation [III] were the same, i.e. there was only one transform T₁ used and that was the Fourier transform. The reason was that the Fourier transform yields perfectly sparse representation for the sinusoid signals.

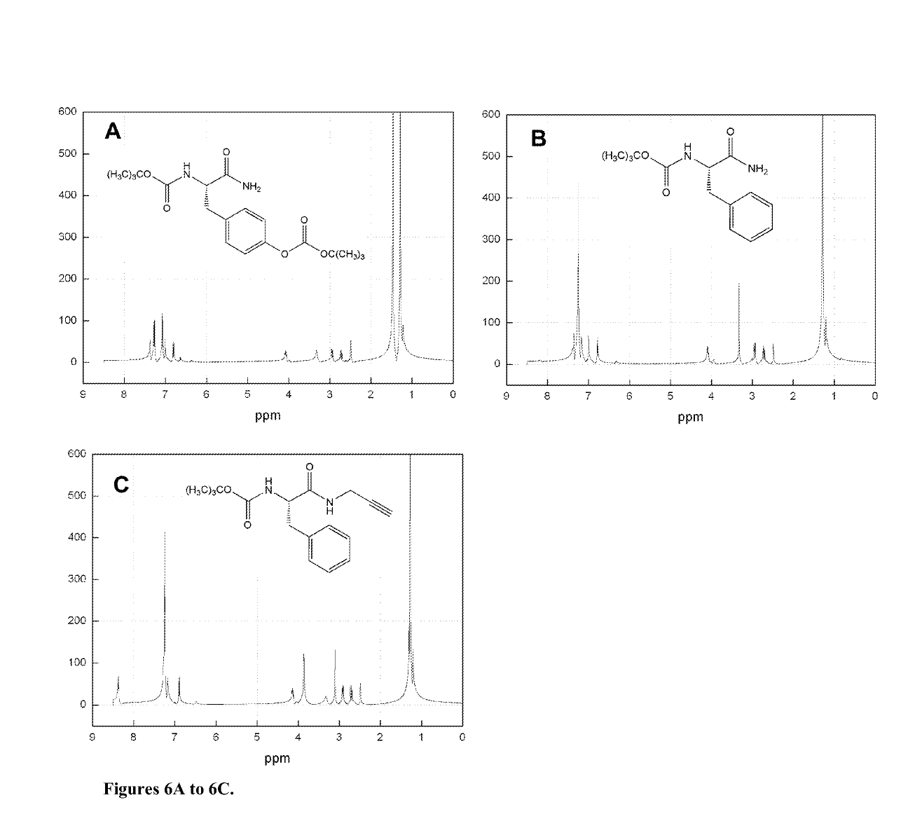

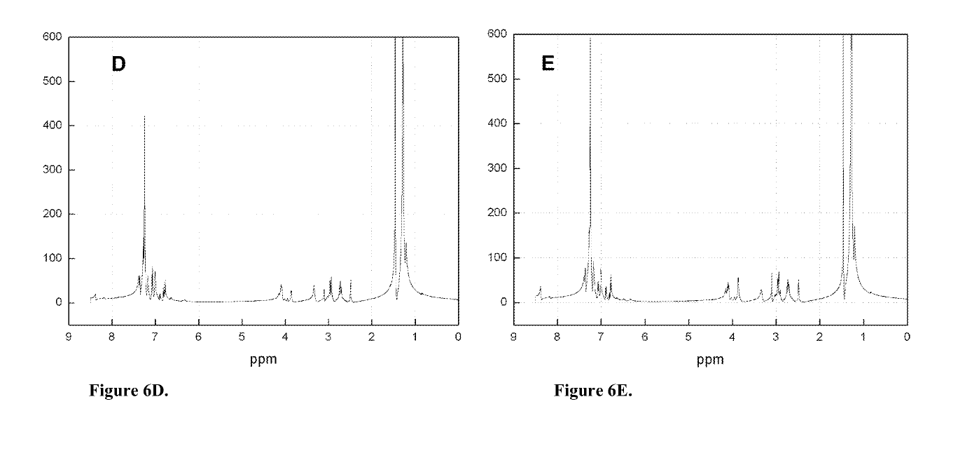

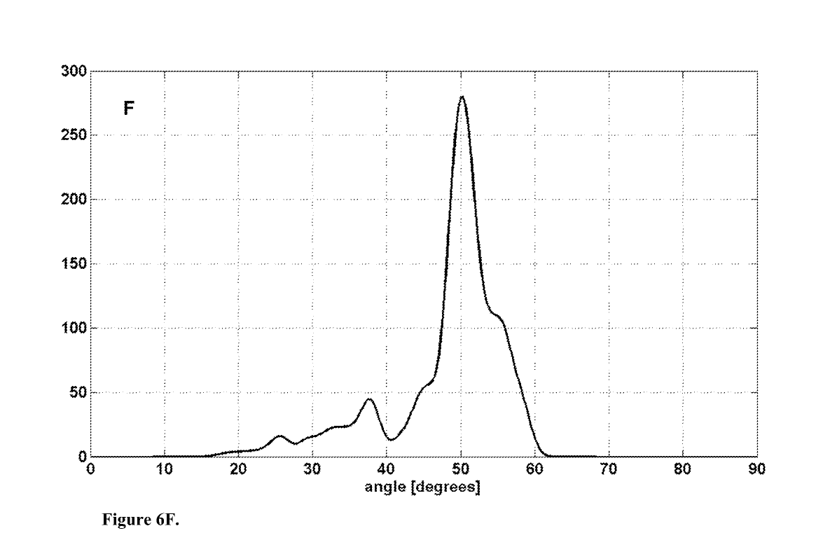

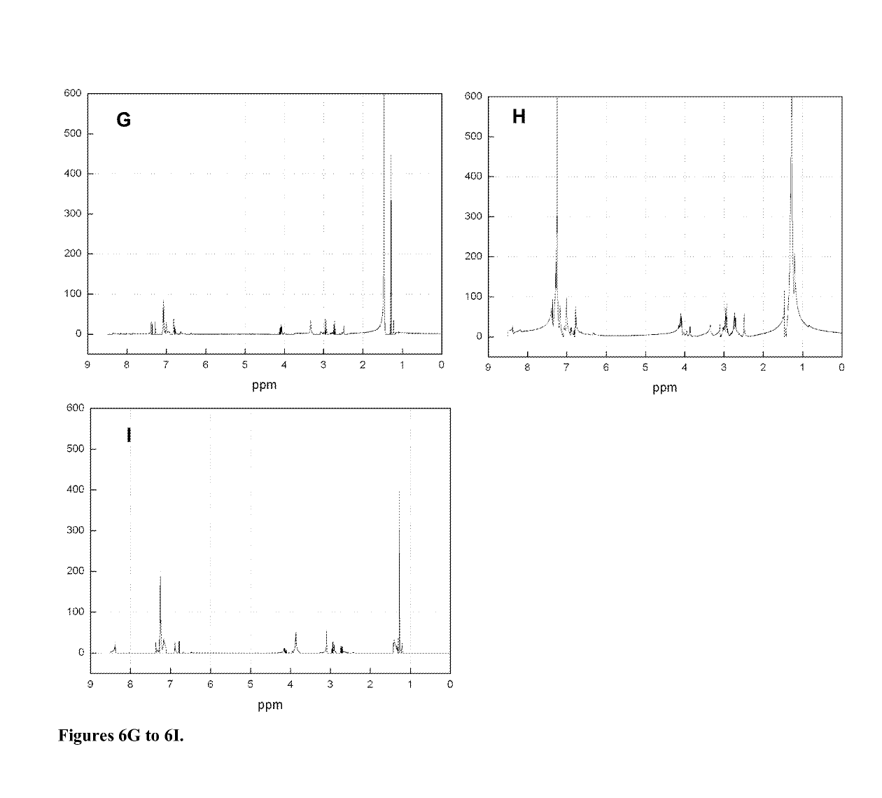

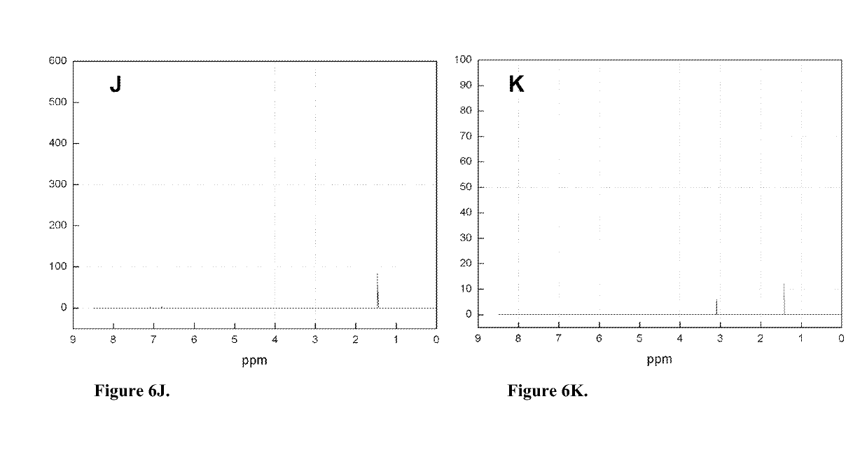

FIGS. 6A to 6K demonstrate experimentally blind extraction of three pure components and two outliers from two ¹H NMR mixtures by means of sparse component analysis according to an embodiment of the present invention. Compounds used in this analysis were derivatives of amino acids tyrosine and phenylalanine with large structural similarities and significant overlapping in NMR spectra. FIGS. 6A to 6C show ¹H NMR amplitude spectra (in the Fourier basis) of the three pure components. Negentropy measures calculated on the amplitude spectra of the three pure components were: 1.955×1017, 2.793×1016 and 2.627×1016. FIGS. 6D and 6E show 1H NMR amplitude spectra of the two mixtures. FIG. 6F shows clustering function in the mixing angle domain wherein for T₁ continuous wavelet transform with the Morlet wavelet has been used to transform two mixtures from recording domain defined by equation [I] to the first new representation domain defined by equation [II]. When the dispersion factor is set to σ=0.04, the number of the pure components is estimated as 4 with the RMSE data reconstruction error RMSE=1.32×10−11. When the dispersion factor is set to σ=0.035 the number of the pure components is estimated as 5 with the RMSE data reconstruction error RMSE=8.1×10'13. The clustering function shown in FIG. 6F illustrates this later case. The amplitude spectra of the estimated pure components that correspond to the three true pure components are shown in FIGS. 6G to 6I. Since in the case of the NMR spectroscopy the frequency (Fourier) domain is the domain where final results are presented, the two mixtures were transformed from the recording domain defined by equation [I] in the second new representation domain defined by equation [III] by transform T₂ that was a Fourier transform. Since linear programming allows that two pure components can overlap at each frequency, we have estimated the pure components in the frequency domain. Negentropy measures calculated on the amplitude spectra of these estimated pure components were: 1.542×1016, 6.602×1016 and 1.379×1012. FIGS. 6J and 6K show the amplitude spectra of two components that are classified as outliers. As it is seen, their amplitudes are between one and two orders of magnitudes smaller than the amplitudes of the estimates of the true pure components. Most importantly, their negentropies were: 1.536×106 and 1.89, that is 10 orders of magnitude or more different that the negentropies of the true pure components. Thus, the negentropy criterion can serve as a basis to discriminate estimates that correspond to the true pure components from those that are classified as outliers. Note also relatively large discrepancy between the third true pure component, FIG. 6C, and their estimate, FIG. 6I. This is consequence of the great spectral similarity between the second and third pure component and small amount of concentration of the third pure component in the mixtures.

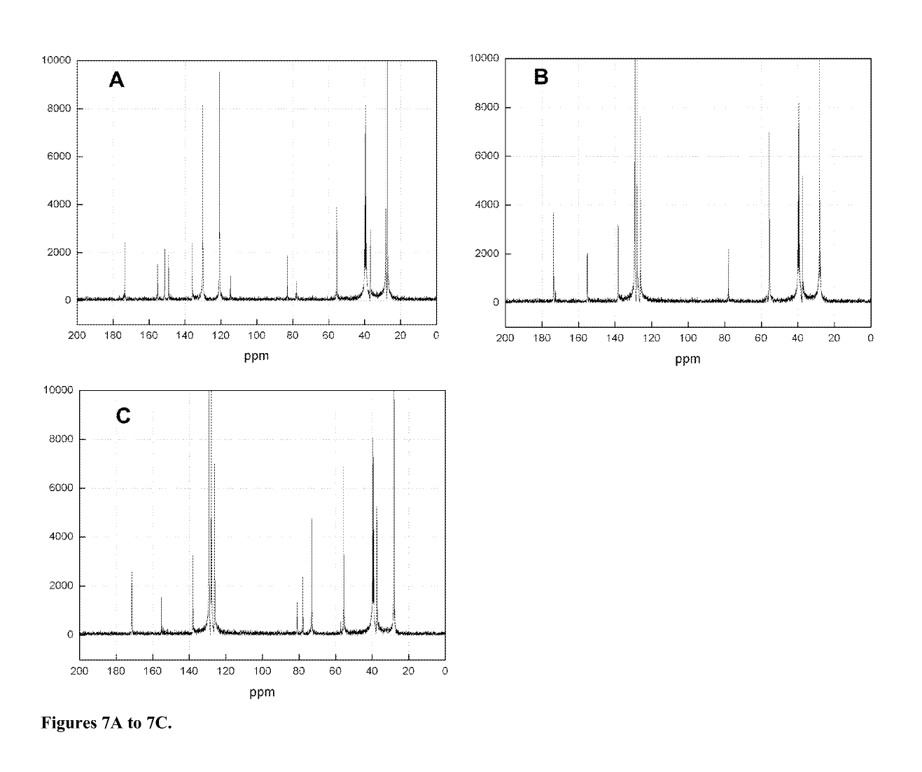

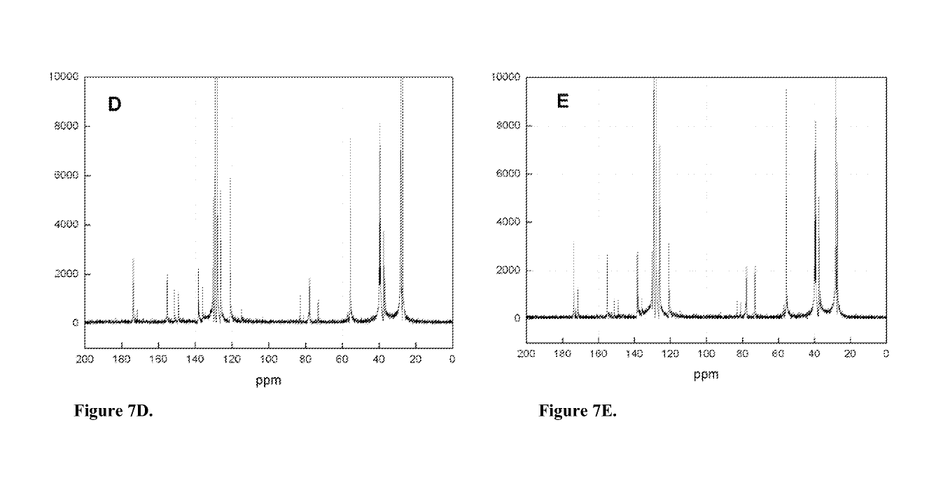

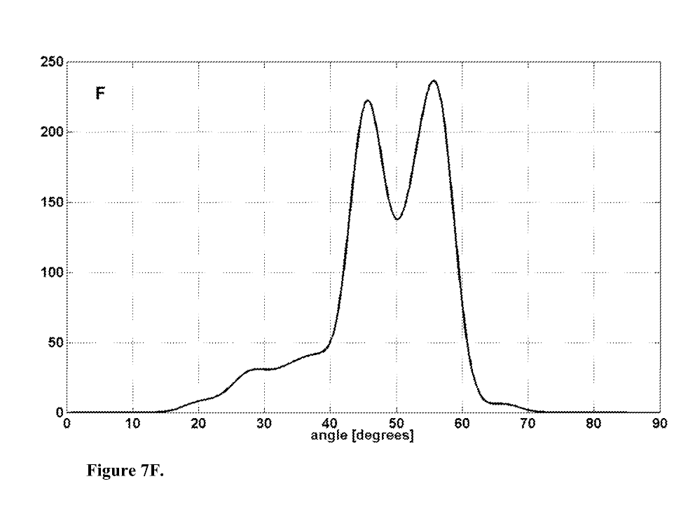

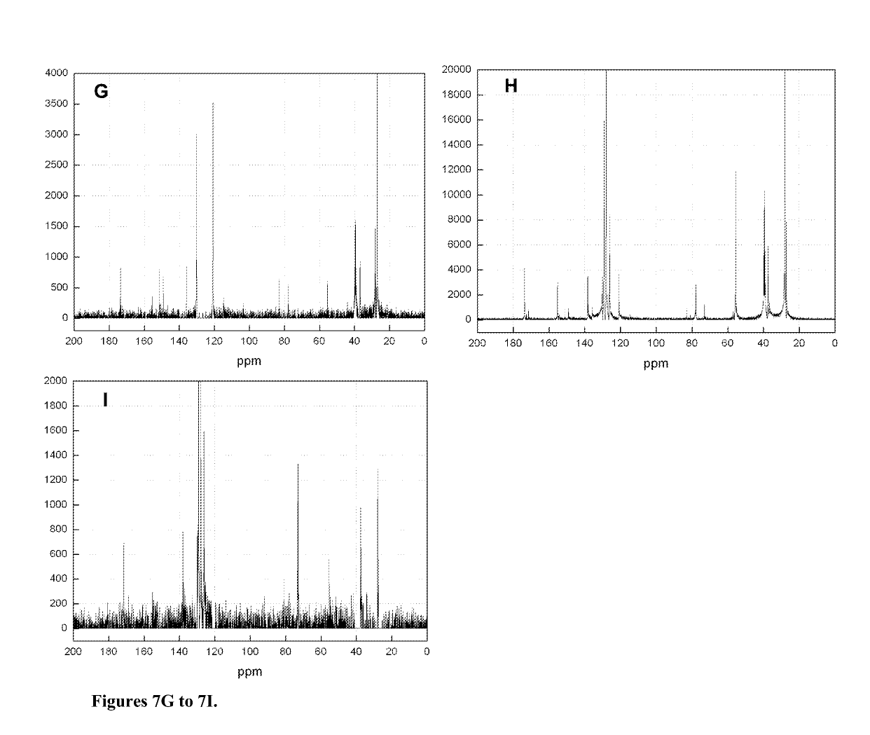

FIGS. 7A to 7I demonstrate experimentally the concept of sparse component analysis by blind extraction of three pure components from two ¹³C NMR mixtures according to an embodiment of the present invention. The compounds used to illustrate the SCA concept on ¹³C NMR data were the same as in the previous paragraph [0061], where the SCA concept was illustrated on 1H NMR data. FIGS. 7A to 7C show ¹³C NMR amplitude spectra (in Fourier basis) of the three pure components. FIGS. 7D and 7E show ¹³C NMR amplitude spectra of the two mixtures. FIG. 7F shows the clustering function in the mixing angle domain, wherein for T₁ continuous wavelet transform with the Morlet wavelet has been used to transform mixtures from recording domain defined by equation [I] to the first new representation domain defined by equation [II]. When the dispersion factor is set to σ=0.0425 the number of the pure components is estimated as 3 with the data reconstruction error RMSE=2.5. The clustering function shown in FIG. 7F illustrates this case. The dispersion factor could be varied as in the previous case of ¹H NMR data and negentropy measure could be used to discriminate estimates of the true pure components from those that are classified as outliers. The amplitude spectra of the estimated pure components that correspond to the true tree pure components are shown in FIGS. 7G to 7I. Note also the relatively large discrepancy between the true third pure component, FIG. 7C, and its estimate, FIG. 7I. This is the consequence of the great spectral similarity between the second and third pure components and the small amount of concentration of the third pure component in the mixtures.

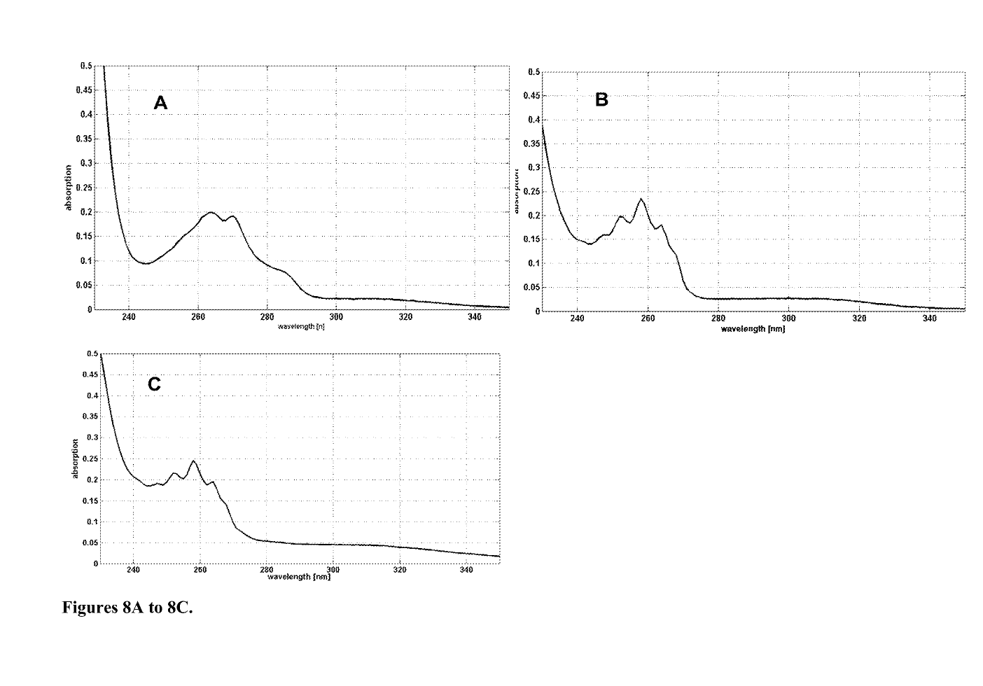

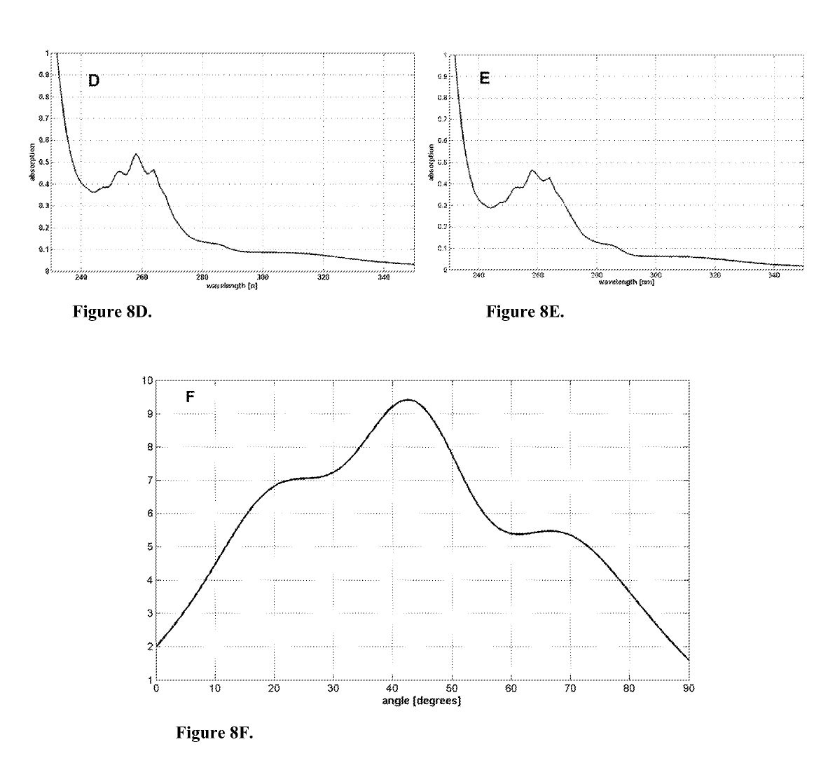

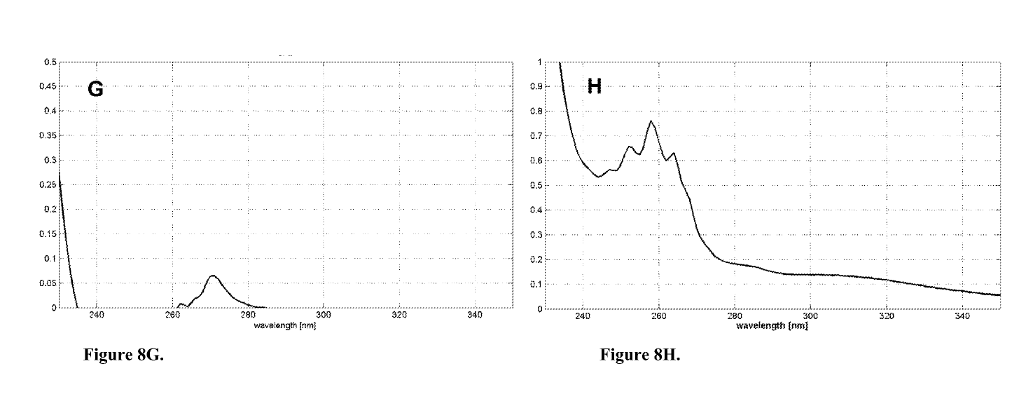

FIGS. 8A to 8H demonstrate experimentally the concept of sparse component analysis by blind extraction of two pure components from two UV mixtures according to an embodiment of the present invention. The compounds used to illustrate the SCA concept on UV data were the same as in the previous paragraphs [0061] and [0062], where the SCA concept was illustrated on ¹H and ¹³C NMR data. FIGS. 8A to 8C show UV spectra of the three pure components. Note that the second and third pure components have the same UV spectra, because they have the same chromophore responsible for the UV absorption (aromatic ring). Consequently, only two true pure components will show up in the mixtures. FIGS. 8D and 8E show UV spectra of the two mixtures defined by equation [I]. FIG. 8F shows the clustering function in the mixing angle domain, wherein for T₁ continuous wavelet transform with the second order Daubechies wavelet has been used to transform two mixtures from recording domain defined by equation [I] to the first new representation domain defined by equation [II]. When the dispersion factor is set to σ=0.09, the number of the pure components is estimated as 3 with the data reconstruction error RMSE=7.4×10−144. The clustering function shown in FIG. 8F illustrates this case. The dispersion factor could be varied as in the previous cases of ¹H and ¹³C NMR data and the negentropy or smoothness measures could be used to discriminate estimates of the true pure components from those that are classified as outliers. The spectra of the estimated pure components that correspond to the true two pure components are shown in FIGS. 8G and 8H. Note the good agreement between the true pure components shown in FIGS. 8A and 8B and their estimates shown in FIGS. 8G and 8H.

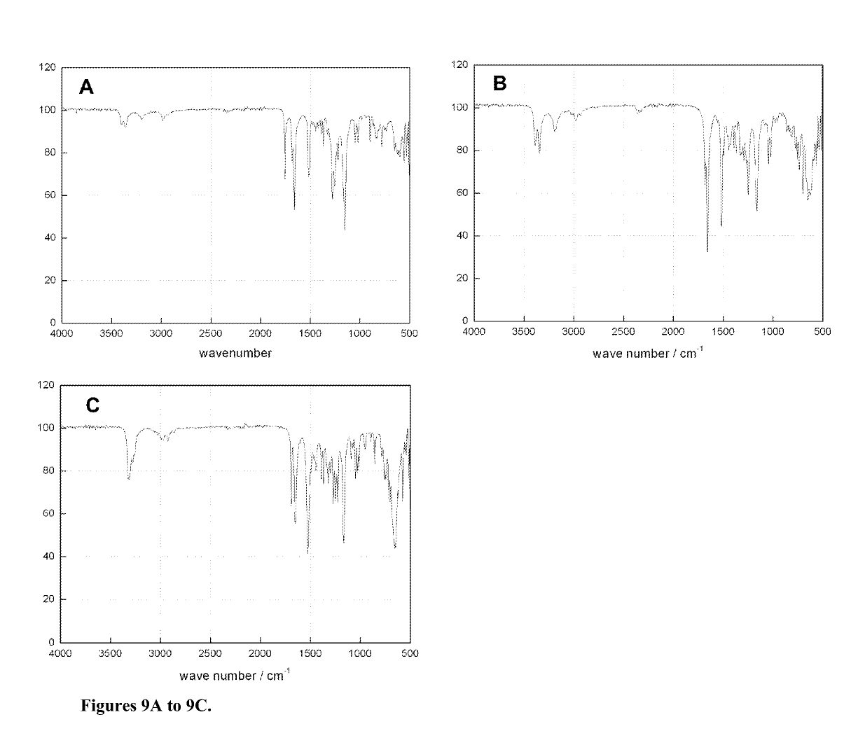

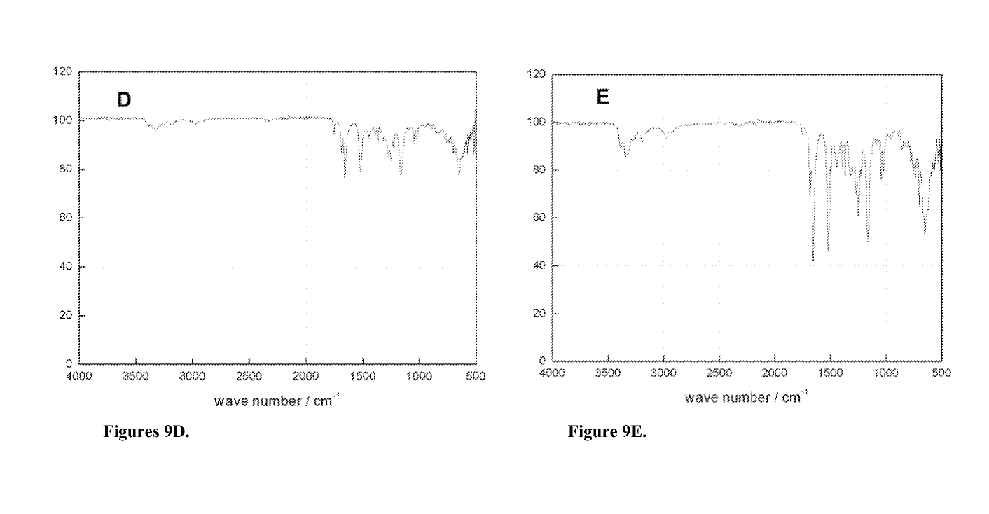

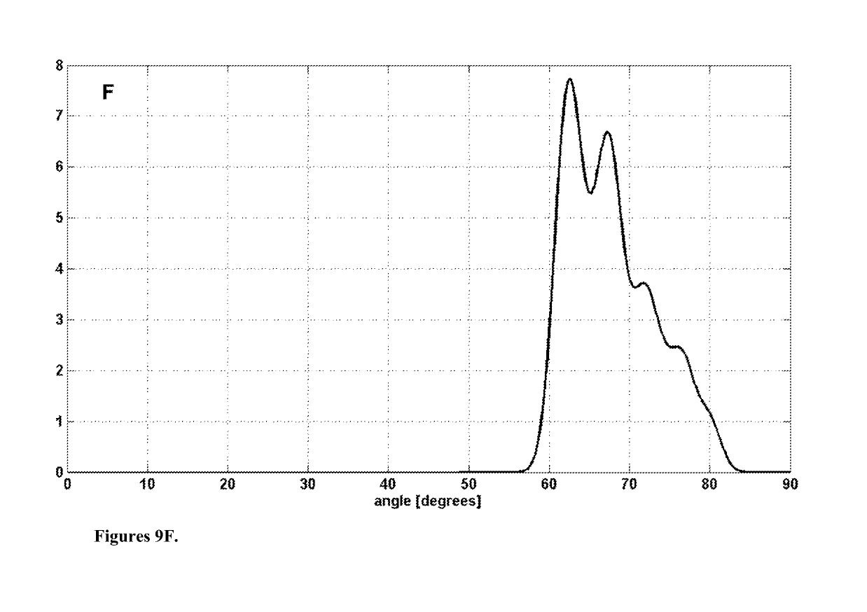

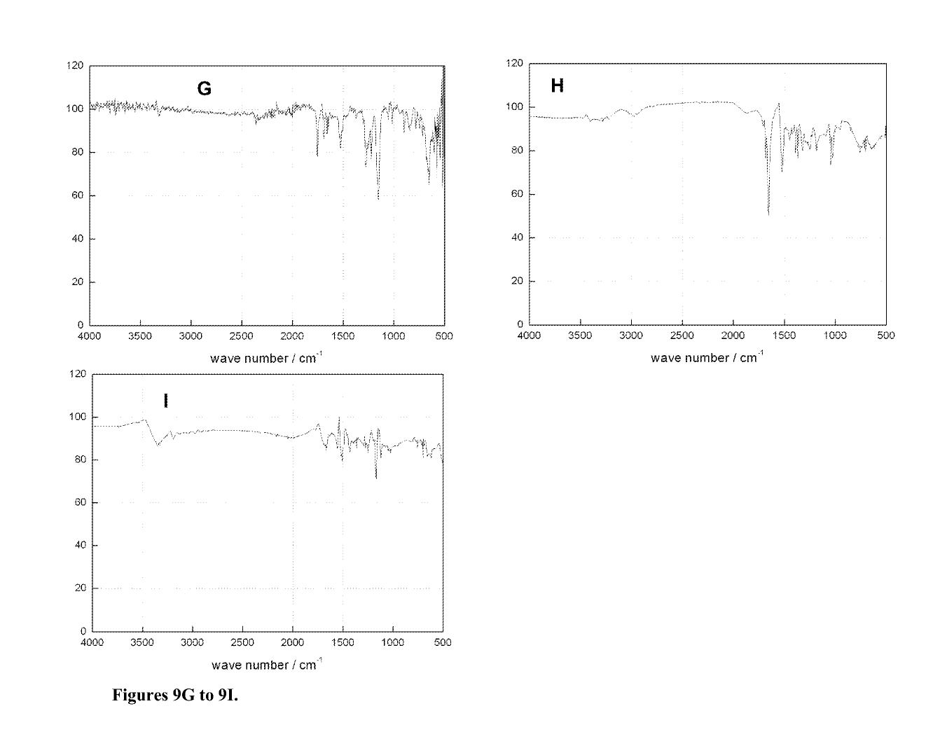

FIGS. 9A to 9I demonstrate experimentally the concept of sparse component analysis by blind extraction of two pure components from two IR mixtures according to an embodiment to the present invention. The compounds used to illustrate the SCA concept on IR data were the same as in the previous paragraphs [0061], [0062] and [0063] where the SCA concept was illustrated on ¹H and ¹³C NMR data and UV data. FIGS. 9A to 9C show IR spectra of the three pure components. FIGS. 9D and 9E show IR spectra of the two mixtures defined by equation [I]. FIG. 9F shows the clustering function in the mixing angle domain, wherein for T₁ continuous wavelet transform with the fourth order symmlet wavelet has been used to transform two mixtures from recording domain define by equation [I] to the first new representation domain defined by equation [II]. When the dispersion factor is set to σ=0.025 the number of the pure components is estimated as 4. The clustering function shown in FIG. 9F illustrates this case. As it was the case with ¹H and ¹³C NMR data, negentropy measure has been used to discriminate estimates of the true pure components from the outlier. The IR spectra of the three estimated pure components that correspond to the three true pure components, are shown in drawings 9G to 9I.

The present invention relates to the field of spectroscopy and spectrometry. More specific, the invention relates to the application of the method of SCA and uBSS for blind extraction of more than two pure chemical compounds from two spectroscopic or spectrometric mixtures, wherein mixtures are gathered by NMR spectroscopy, EPR spectroscopy, IR spectroscopy, UV spectroscopy, Raman spectroscopy or mass spectrometry. Proposed blind mixture decomposition approach estimates the unknown number of pure components from the mixtures. Identified pure components can be used for identification of the compounds in chemical synthesis, food quality control, environment protection, etc.

The enabling concept for blind extraction of more than two possibly statistically dependent pure components from two mixtures only is known under the common name sparse component analysis (SCA). The concept is schematically illustrated in FIGS. 2A to 2F where four sinusoid signals with different frequencies are blindly extracted from two mixtures only.

Theoretical foundations of the solution of the uBSS problems employing SCA are laid down in: P. Bofill and M. Zibulevsky, “Underdetermined blind source separation using sparse representations. Signal Processing 81, 2353-2362, 2001; Y. Li, A. Cichocki, S. Amari, “Analysis of Sparse Representation and Blind Source Separation,” Neural Computation 16, pp. 1193-1234, 2004; Y. Li, S. Amari, A. Cichocki, D. W. C. Ho, S. Xie, “Underdetermined Blind Source Separation Based on Sparse Representation,” IEEE Trans. on Signal Processing, vol. 54, No. 2, 423-437, 2006; P. Georgiev, F. Theis, and A. Cichocki, “Sparse Component Analysis and Blind Source Separation of Underdetermined Mixtures,” IEEE Trans. on Neural Networks, vol. 16, No. 4, 992-996, 2005.

Let us assume the number of mixtures to be n and the unknown number of pure components to be m. The uBSS problem is solvable by SCA approach, if pure components in some domain are (m−n+1)-sparse what implies that at each coordinate (for example frequency in Fourier basis) m−n+1 components are zero. By setting the number of mixtures to be n=2 this implies that at each coordinate in the domain of representation m−1 pure components must be zero, i.e., the assumption is that pure components do not overlap in new representation domain. This assumption is recently relaxed by a concept known as k-plane clustering: F. M. Naini, G. H. Mohimani, M. Babaie-Zadeh, Ch. Jutten, “Estimating the mixing matrix in Sparse Component Analysis (SCA) based on partial k-dimensional subspace clustering,” Neurocomputing 71, 2330-2343, 2008; Y. Washizava, A. Cichocki, “On-Line k-plane clustering learning algorithm for sparse component analysis,” in: Proceedings of ICASSP'06, Toulouse, France, pp. 681-684, 2006. Robustness with respect to noise and outliers is achieved by assuming that pure components are in average (m−n+1)-sparse. Hence, it is allowed that pure components at certain number of coordinates violate (m−n+1)-sparseness assumption. In the sequel we shall assume the pure components are in average m−1 sparse in the new representation domain wherein only two mixtures are available.

As already elaborated, the number of pure components residing in the recorded mixtures is always unknown. Accurate estimation of this number is a challenging task and is accomplished by fairly complex statistical methods such as maximum likelihood, bootstrapping and jack-knifing: F. Westad, M. Kermit, “Cross validation and uncertainty estimates in independent component analysis,” Analytica Chimica Acta 490, 341-354, 2003; E. Levina et al., “Estimating the number of pure chemical components in a mixture by maximum likelihood,” Journal of Chemometrics 21, 24-34, 2007. These methods are based on statistical ranking the singular values of the sample data covariance matrix by discarding those that may be associated with outliers or chemical noise. In solving uBSS problems such methods can not be applied because the number of pure components exceeds the overall number of singular values that equals the number of mixtures. In the case of the present invention that is two.

According to the present invention the unknown number of pure components during the mixing matrix estimation phase in the new representation domain is estimated by means of the clustering method recently proposed in: F. M. Naini et al., “Estimating the mixing matrix in Sparse Component Analysis (SCA) based on partial k-dimensional subspace clustering,” Neurocomputing 71, 2330-2343, 2008.

When the mixing matrix is estimated, the pure components are recovered by solving an underdetermined system of linear equations in the new representation domain. If the pure components are in average m−1 sparse, the solution can be obtained by several methods that are based on constrained convex optimization: J. A. Tropp, A. G. Gilbert, “Signal Recovery From Random Measurements Via Orthogonal Matching Pursuit,” IEEE Transactions on Information Theory, vol. 53, No. 12, 4655-4666, 2007; S. J. Kim et al., “An Interior-Point Method for Large-Scale l₁-Regularized Least Squares,” IEEE Journal of Selected Topics in Signal Processing, vol. 1, No. 4, 606-617, 2007. Moreover, it has been proven (I. Takigawa, M. Kudo J. Toyama, “Performance Analysis of Minimum I1-Norm Solutions for Underdetermined Source Separation,” IEEE Tr. on Signal Processing, vol. 52, No. 3, 582-591, 2004) that linear programming yields perfect solution when mixing matrix is known and when no more than n sources are active at each coordinate, i.e. when sources are (m−n)-sparse. By fixing the number of mixtures to be n=2 this implies that linear programming will yield an accurate solution for the (m−2)-sparse components, i.e., at each coordinate at most 2 pure components are allowed to exist. Since the described clustering algorithm requires that pure components be in average (m−1)-sparse they are automatically (m−2)-sparse. Hence, linear programming will yield a robust solution of the blind spectra decomposition problem, if no more than 2 pure components are active at each frequency coordinate.

Blind extraction of the pure components from two mixtures data X is achieved by the combined use of linear transform T₁ to transform recorded mixtures into the first new representation domain defined by equation [II] where transformed pure components are sparse, estimating the unknown mixing or concentration matrix and the unknown number of pure components in the first new representation domain defined by equation [II] by means of data clustering algorithm described in [0068], [0075], [0076], estimating the unknown pure components by means of linear programming, constrained convex programming or constrained quadratic programming either in the first new representation domain defined by equation [II] or the second new representation domain defined by equation [III] obtained by linear transformation of the two mixtures defined by equation [I] by another linear transform T₂, and applying inverse of the transform T₁ on estimated pure components, if the domain, where results are presented, differs from the first new representation domain defined by equation [II].

The problem of the blind decomposition of two recorded mixtures by means of the SCA algorithms can algebraically be expressed as a matrix factorization problem XεR^{n×N} by means of which recorded mixtures are represented by equation [I]:

X=AS [I]

In equation [I] X represents recorded two mixtures data, where ZεR₀₊^{n×m} represents unknown mixing matrix (also called concentration matrix) and SεR^{m×N} represents matrix of the unknown pure components. In adopted notation n=2 represents number of recorded spectroscopic or spectrometric mixtures, N represent number of samples in the mixture, and m represents unknown number of the pure components. When referring to individual mixtures one or two we shall use notation x₁ or x₂ respectively. They are represented by the corresponding rows of the mixture matrix X. Since we are assuming m≧n, wherein n=2, resulting blind source separation problem is underdetermined. Such kind of blind problems can not be solved by means of the ICA algorithms discussed in paragraphs [0004] and [0005].

In the present invention, a term “the two mixtures recording domain” is defined by equation [I]. A domain which was obtained by applying linear transform on the mixtures in recording domain defined by equation [I], and which is called in the present invention “the first new representation domain” is defined by equation [II]. Also, domain which was obtained by applying linear transform T₂ on the mixtures in recording domain defined by equation [I], and which is called in the present invention “the second new representation domain” is defined by equation [III]. A term “results presentation domain” relates to the domain where results obtained by blind decomposition algorithm ought to be presented. Depending on the mixtures sensing device that relates to the chosen spectroscopic technology the results presentation domain can be mixtures recording domain defined by equation [I], the first new representation domain defined by equation [II] or the second new representation domain defined by equation [III].

As previously discussed in paragraphs [00065]-[00070], underdetermined blind source separation problem is solvable if pure components are m−1 sparse in the first new representation domain one that is obtained by applying linear transform on the recorded mixtures given by equation [I]:

T₁(X)=AT₁(S) [II]

The challenge is to find the linear transform T₁ that will produce m−1 sparse representations of the pure components T₁(S). We remind that m−1 sparse representations means that at each coordinate in the first new representation domain defined by equation [II] at most one pure component is non-zero i.e. it is assumed that pure component do not overlap in the first new representation domain defined by equation [II]. Candidates for the linear transform T₁ are the Fourier transform or wavelet transform. The Fourier transform can be a good choice for ¹³C NMR data, where a small degree of overlap between pure components is expected. However the m−1 sparseness requirement is not very likely to be met, when Fourier transform is applied on ¹H NMR data or some other spectroscopic or spectrometric data.

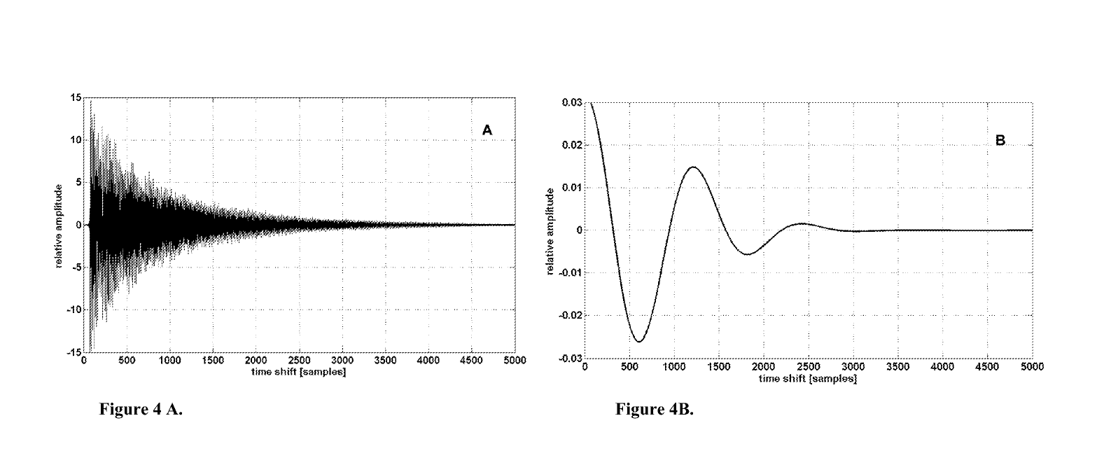

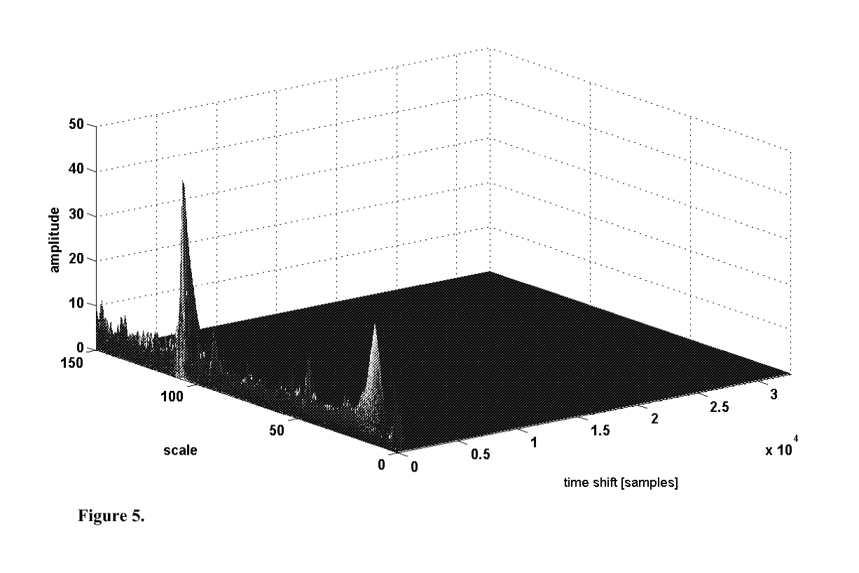

The wavelet transform has greater chance to yield sparse pure components T₁(S) due to possibility to choose a wavelet basis function that matches the structure of the spectroscopic or spectrometric signals defined by equation [I]. For example it will be demonstrated that Morlet and Mexican hat wavelets match the structure of the NMR signals very well. Thus, the Morlet or Mexican hat based wavelet transform yields very sparse representation of the NMR signals. For example, FIGS. 4A and 4B respectively show the real part of the time domain ¹H NMR signal (pure component) and Morlet wavelet at the corresponding scale. The similarity of the waveforms is evident. Hence, by transforming (projecting) time domain data on the basis defined by Morlet or Mexican hat wavelet it is expected to obtain large values of the wavelet coefficients at the few scale (resolution) levels only. This conjecture is further supported by FIG. 5. It shows the normalized absolute value of the wavelet coefficients vs. scales (resolution levels) and time shifts that is obtained by transforming time domain ¹H NMR data shown in FIG. 4A to the scale-time shift domain by means of the continuous wavelet transform and Mexican hat wavelet. Large values of the wavelet coefficients exist at the few scales only. Likewise, for the fixed scale parameter large values of the wavelet coefficients exist at the few time shifts only. Thus, choosing transformed data at the scale which gives maximal value of the wavelet coefficients yields very sparse representation of the NMR signals in the wavelet basis. As opposed to this the same NMR signal in Fourier domain, shown in 6B, is evidently not so sparse. It is a nontrivial problem to identify the optimal wavelet function for other types of spectroscopic or spectrometric data.

For two mixtures data model defined by equation [I] the number of mixtures used in the representation described in paragraph [0073] is n=2. The number of unknown pure components m contained in recorded mixtures defined by equation [I] has to be estimated. As elaborated in [0069] advanced statistical methods developed for overdetermined BSS problems (m>n) are not applicable to underdetermined BSS problem. According to an embodiment of the present invention we adopt the approach proposed in: F. M. Naini et al., “Estimating the mixing matrix in Sparse Component Analysis (SCA) based on partial k-dimensional subspace clustering,” Neurocomputing 71, 2330-2343, 2008. Assuming the number of mixtures to be n=2, we model the column vectors of the mixing matrix (we also call them mixing vectors) as unit length vectors with mixing angles describing their position in the mixtures x₁-x₂ coordinate system a=[cos(φ)sin(φ)]^{T} (illustration is given in FIG. 3). Since the mixing matrix has the chemical interpretation of concentrations of the pure components in the mixtures, it is nonnegative. Thus the mixing angles are confined in the interval [0, π/2].

Provided that small samples of the two mixtures in the first new representation domain defined by equation [II] are eliminated and that remaining samples are normalized to unit length, the following function

$$f ( a ) = {\sum }_{i = 1}^{\overline{N}} exp ( - \frac{{d}^{2} ( {T}_{1} ( {x}_{i} ) , a )}{2 {σ}^{2}} )$$

clusters mixtures data in the first new representation domain defined by equation [II] into the clusters the number of which corresponds with the number of pure components.
N̅≦N denotes the number of samples that remained after small samples elimination process. In the clustering function f(a), d denotes distance calculated as d((T₁(xᵢ),a))={square root over (1−(T₁(xᵢ)·a)²)} and (T₁(xᵢ)·a) denotes the inner or dot product. Parameter σ defines the resolving power of the function f(a). When σ is set to a sufficiently small value, in our experiments this turned out to be σ≈0.05, the value of the function f(a) will approximately equal the number of data points close to a. Positions of the centers of the clusters in the space of mixing angles correspond with the mixing angles that define the mixing vectors. FIG. 2E shows the clustering function for the example when four sinusoid signals with different frequencies were mixed into two mixtures and then transformed into Fourier domain, i.e. T₁ is implemented by Fourier transform. Two more examples are shown in FIGS. 6F and 7F for the case of experimental ¹H and ¹³C NMR data comprised of three pure components with one component contained in small concentration and two components contained in similar concentrations.

After the number of pure components and the mixing matrix are estimated, the pure components themselves ought to be estimated. This can be achieved either in the first new representation domain defined by equation [II] and implemented by transform T₁, or in the second new representation domain defined by equation [III] and obtained by applying linear transform T₂ on the two mixtures defined by equation [I]. This yields

T₂(X)=AT₂(S) [III]

Provided that either pure components in the first new representation domain defined by equation [II] or the second new representation domain defined by equation [III] are m−2 sparse linear programming will yield accurate solution for the estimate of the pure components T₁(S) or T₂(S) based on the estimate of the mixing matrix A and transformed mixtures T₁(X) defined by equation [II] or T₂(X) defined by equation [III]. This result has been proven in: I. Takigawa, M. Kudo J. Toyama, “Performance Analysis of Minimum I1-Norm Solutions for Underdetermined Source Separation,” IEEE Tr. on Signal Processing, vol. 52, No. 3, 582-591, 2004. Other methods for estimation of the pure components T₁(S) in the first new representation domain defined by equation [II] or T₂(S) in the second new representation domain defined by equation [III] that are based on the estimate of the mixing matrix A and transformed data T₁(X) or T₂(X) include: matching pursuit algorithm (Mallat, S., Zhang, Z, “Matching pursuits with time-frequency dictionaries,” IEEE Transactions on Signal Processing, 41(12), 3397-3415, 1993); orthogonal matching pursuit algorithm (Tropp, J. A., Gilbert, A. C., “Signal Recovery From Random Measurements Via Orthogonal Matching Pursuit,” IEEE Transactions on Information Theory, 53(12), 4655-4666, 2007); interior-point method specialized for large-scale l₁-regularized least squares problems (Kim, S. J., Koh, K., Lustig, M., Boyd, S., Gorinevsky, D., “An Interior-Point Method for Large-Scale l₁-Regularized Least Squares,” IEEE Journal of Selected Topics in Signal Processing, 1(4), 606-617, 2007).

Transform T₂ is useful when the domain in which results are presented differs from the two mixtures recording domain defined by equation [I] and from the first new representation domain defined by equation [II] obtained by means of transform T₁. Provided that transformed pure components T₂(S) are comparably sparse as the transformed components T₁(S), the second new representation domain defined by equation [III] enables the estimation of the pure components. For example, when sparse component analysis is applied for blind decomposition of NMR mixtures, the mixing matrix is most accuratley estimated in the new representation domain one defined by equation [II], wherein transform T₁ represents wavelet basis with either Morlet or Mexican hat wavelets. This is because such basis provides the sparsest representation of the NMR signals. On the other hand it is customary to present results of the NMR data analysis in the frequency domain (in the ppm scale). Thus, if Fourier transform is chosen for the transform T₂, where pure components are comparably sparse as in the wavelet basis, pure components can be estimated directly in the frequency domain. Due to the result cited in the previous paragraph, pure components T₂(S) ought only to be m−2 sparse, what actually relaxes the sparseness requirement on the Fourier bases when it is used for the transform T₂. Thus, in the case of NMR data, when pure components T₂(S) are estimated in the Fourier basis, no inverse transform T₁⁻¹ from the first new data representation domain defined by equation [II] to the two mixtures recording domain defined by equation [I] and then direct transform T₂ from two mixtures recording domain defined by equation [I] to the second new representation domain defined by equation [III] are necessary.

If the pure components are estimated in the first new representation domain defined by equation [II] and results ought to be presented in the two mixtures recording domain defined by equation [I], the inverse transform T₁⁻¹ must be used to obtain estimated pure components in the two mixtures recording domain defined by equation [I], i.e.

S=T₁⁻¹(T₁(s)) [IV]

For example, this is necessary when sparse component analysis is applied to blind decomposition of IR, UV or Raman spectroscopic data, wherein direct transform T₁ and inverse transform T₁⁻¹ are wavelet and inverse wavelet transforms with suitable chosen wavelet function.

As explained in paragraph [0078] the number of pure components is estimated simultaneously with the mixing matrix employing a data clustering algorithm in the first new representation domain defined by equation [II]. The sensitivity of the clustering function is regulated through the dispersion factor σ. Since the experimental data can contain errors due the presence of chemical noise or outliers, as discussed in the US patent application 20040111220 in paragraph [0015], it is necessary to derive a robust estimator of the number of pure components. For this purpose we propose to slightly variate the dispersion factor σ and estimate the mixing matrix, related number of pure components m and pure components themselves for each value of σ. To evaluate the quality of the estimates of the mixing matrix and pure components we propose to use the root-mean-squared-error (RMSE) criterion between original and reconstructed data as for example in: G. Wang, W. Cai, X. Shao, “A primary study on resolution of overlapping GC-MS signal using mean-field approach independent component analysis,” Chemometrics and Intelligent Laboratory Systems 82, 137-144, 2006.

$$R M S E ( m ) = \sqrt{\frac{{\sum }_{i = 1}^{n} {\sum }_{j = 1}^{N} {( {x}_{i} ( j ) - {\sum }_{k = 1}^{m} {a}_{ik} {s}_{k} ( j ) )}^{2}}{nN}}$$

As the solution for the mixing matrix A and pure components S we present the one that minimizes RMSE criterion.

When working with experimental data, the presence of outliers (sources that are not pure components in the true sense but are the consequence of chemical noise or other imperfections present in the real world applications) must be allowed. In order to discriminate estimated pure components that correspond to the true pure components from the outliers we propose an information theoretic measure called negentropy: A. Hyvärinen, J. Karhunen, E. Oja. Independent Component Analysis, John Wiley, 2001. Negentropy is entropy defined relatively in relation to the entropy of the Gaussian random process. Since the Gaussian random process has the largest entropy its negentropy will be zero. The more informative (non-Gaussian) the random process is, the largest negentropy it has. Since we intuitively expect the pure components to be informative we also expect their negentropies to be large. As opposed to that we expect the negentropies of the possible outliers to be small.

The present invention is related to blind extraction of more than two pure components from the two mixtures of the chemical compounds by means of sparse component analysis and underdetermined blind source separation. The invention is insensitive to statistical dependence among the pure components and is capable of automatically determining their number from the two available mixtures.

As opposed to the state-of-the art blind spectra decomposition methods that require the number of measured spectral data (also called mixtures) to be equal to or greater than the unknown number of pure components, paragraphs [0003]-[0013], proposed SCA approach requires measurement of two mixtures only for blind extraction of more than two pure components. Also, as opposed to the blind spectra decomposition methods referred to as state-of-the-art, proposed blind spectra decomposition approach does not require the number of pure components to be known in advance but estimates it from the available measured data.

It is clear from the to be elaborated sparse component analysis and underdetermined BSS concepts that full exploitation of the redundancies present in the spectroscopic data enables solution of the related BSS problem by using two mixtures only, what is the main characteristic of the present invention.

The present invention solves blind decomposition problem using two mixtures only and estimates the unknown number of pure components using data clustering algorithm commented in paragraphs [0068], [0077] and [0078]. It is related to spectroscopy where sparseness is generally not ensured but is achieved by transforming recorded data into either Fourier or wavelet basis with properly chosen wavelet function that matches the structure of the related spectroscopic or spectrometric signals. The present invention estimates mixing matrix using purely geometric approach known as data clustering. In particular an algorithm is used (F. M. Naini, et. al, “Estimating the mixing matrix in Sparse Component Analysis (SCA) based on partial k-dimensional subspace clustering,” Neurocomputing, vol. 71, pp. 2330-2343, 2008) that assumes that in the given basis sources, or pure components, are in average 1-sparse. This presumes that at the majority of coordinates in the transformed basis (also called first new representation domains defined by equation [II] or the second new representation domain defined by equation [III]) only one source is active. As demonstrated in the innovation this is fulfilled by using continuous wavelet transform with properly chosen resolution level and wavelet function that resembles structure of the spectroscopic signal of interest. Moreover, it has been demonstrated in the presented innovation that high level of sparseness among the pure components can not be ensured in the Fourier basis i.e. frequency domain, but in wavelet basis with a carefully chosen wavelet function that resembles time structure of the signals arising in spectroscopy. Specifically, it has been found in the presented innovation that the highest level of sparseness, when NMR signals are projected to wavelet basis, is achieved when Morlet's wavelet or Mexican hat wavelet (the second order derivative of the Gaussian function) are chosen for wavelet function in the continuous wavelet transform.

The invention can be applied to identification of the compounds in the pharmaceutical industry in the chemical synthesis of new compounds with different properties. It can also be applied in the food quality inspection and environment protection through pollution inspection. Another application of the proposed invention is in software packages, as the built in computer code, that are used for the analysis and identification of the chemical compounds.

1. A method of blind extraction of more than two pure components out of spectroscopic or spectrometric measurements of only two mixtures using sparse component analysis, comprising the steps of:
recording two mixtures data X using a mixtures sensing device wherein a recording domain of the two mixture data is defined by equation [I]:
X=AS [I]
where S is an unknown matrix of pure components and A is an unknown mixing or concentration matrix,
storing the recorded two mixtures data in a data storing device,
executing instructions on a processor of an instruction executing computer for:
transforming the two mixtures data X into a first new representation domain by using linear transform wherein the transformed mixtures T₁(X) are represented by equation [II]:
T₁(X)=AT₁(S) [II]
and pure components in the first new representation domain defined by equation [II] are sparser than in recording domain defined by equation [I],
estimating the number of pure components S and the mixing or concentration matrix A in the first new representation domain defined by equation [II] by means of a data clustering algorithm,
provided that the results presentation domain is the recording domain of the two mixtures data, estimating the mixing or concentration matrix A and the number of the pure components T₁(S) in the first new representation domain by means of linear programming, constrained convex programming or constrained quadratic programming,
inverse transforming the estimated pure components T₁(S) from the first new representation domain defined by equation [II] to the recording domain defined by equation [I] by applying the inverse of the transform T₁ according to equation [IV]:
S=T₁⁻¹(T₁(S)) [IV]
provided that the results presentation domain is the second new representation domain defined by equation [III], transforming the mixtures data from the recording domain defined by equation [I] to a second new representation domain by using linear transform T₂, wherein the transformed mixtures T₂(X) are represented by equation [III]:
T₂(X)=AT₂(S) [III]
and pure components in the second new representation domain defined by equation [III] are sparser than in recording domain defined by equation [I],
estimating the pure components in the second new representation domain defined by equation [III] by means of linear programming, constrained convex programming or constrained quadratic programming,
selecting the estimated pure components in accordance with the negentropy-based raking criteria, and
outputting output data including an identification of the estimated selected pure components to an output device for displaying or storing output data.

2. The method of claim 1, wherein the linear transform T₁ is a wavelet transform with either Morlet or Mexican hat wavelet.

3. The method of claim 1, wherein the linear transform T₂ is a Fourier transform.

4. The method of claim 3, wherein the data clustering algorithm is of the type capable to simultaneously estimate the mixing matrix and the number of pure components in the first new representation domain.

5. The method of claim 4, wherein a numerical method is used to estimate the pure components in the second new representation domain that is a linear programming method, a convex programming method with quadratic constraint (l₂-norm based constraint) or a quadratic programming method with l₁-norm based constraint.

6. The method of claim 2, wherein the linear transform T₁ is a wavelet transform with the second to eight order Daubechies wavelets or symlets or coiflets of the order one to five.

7. The method of claim 6, wherein the data clustering algorithm is of the type capable to simultaneously estimate the mixing matrix and the number of pure components in the first new representation domain.

8. The method of claim 7, wherein a numerical method is used to estimate the pure components in the first new representation domain that is a linear programming methods, a convex programming method with quadratic constraint (l₂-norm based constraint) or a quadratic programming method with l₁-norm based constraint.

9. The method of claim 1, wherein said method is applied to the identification of the compounds in chemical synthesis, food quality inspection or pollution inspection.

10. Computer-readable medium having computer-executable instructions stored thereon which, when executed by a computer, will cause the computer to carry out the method of claim 1.

11. A system for blind extraction of more than two pure components out of spectroscopic or spectrometric measurements of only two mixtures by means of sparse component analysis, comprising:
an instruction executing computer having a data storing device, a processor, and an output device;
a mixtures sensing device for recording mixtures data X, wherein a recording domain of the two mixture data is defined by equation [I]:
X=AS [I]
where S is an unknown matrix of pure components and A is an unknown mixing or concentration matrix,
said data storing device receiving and storing the mixture data X recorded by the mixtures sensing device,
instructions executed on said processor for processing the mixtures data X stored in the input data storing device, for:
transforming the two mixtures data X into a first new representation domain by using linear transform T₁ wherein the transformed mixtures T₁(X) are represented by equation [II]:
T₁(X)=AT₁(S) [II]
and pure components in the first new representation domain defined by equation [II] are sparser than in recording domain defined by equation [II],
estimating the number of pure components S and the mixing or concentration matrix A in the first new representation domain defined by equation [II] by means of a data clustering algorithm,
provided that the results presentation domain is the recording domain of the two mixtures data, estimating the mixing or concentration matrix A and the number of the pure components T₁(S) in the first new representation domain by means of linear programming, constrained convex programming or constrained quadratic programming,
inverse transforming the estimated pure components T₁(S) from the first new representation domain defined by equation [II] to the recording domain defined by equation [I] by applying the inverse of the transform T₁ according to equation [IV]:
S=T₁⁻¹(T₁(S)) [IV]
provided that the results presentation domain is the second new representation domain defined by equation [III], transforming the mixtures data from the recording domain defined by equation [I] to a second new representation domain by using linear transform T₂, wherein the transformed mixtures T₂(X) are represented by equation [III]:
T₂(X)=AT₂(S) [III]
and pure components in the second new representation domain defined by equation [III] are sparser than in recording domain defined by equation [I],
estimating the pure components in the second new representation domain defined by equation [III] by means of linear programming, constrained convex programming or constrained quadratic programming,
selecting the estimated pure components in accordance with the negentropy-based raking criteria, and
outputting output data including an identification of the estimated selected pure components; and
said output device for displaying or storing output data.

12. (canceled)

13. The system of claim 11, wherein the mixtures sensing device is a nuclear magnetic resonance (NMR) spectrometer, ultraviolet spectrometer, IR spectrometer, electron paramagnetic resonance spectrometer, Raman spectrometer or mass spectrometer.

14. The system of claim 13, wherein the linear transform T₁ is a wavelet transform with either Morlet or Mexican hat wavelet.

15. The system of claim 14, wherein the linear transform T₂ is a Fourier transform.

16. The system of claim 15, wherein the data clustering algorithm is of the type capable to simultaneously estimate the mixing matrix and the number of pure components in the first new representation domain.

17. The system of claim 16, wherein a numerical method is used to estimate the pure components in the second new representation domain that is a linear programming method, a convex programming method with quadratic constraint (l₂-norm based constraint) or a quadratic programming method with l₁-norm based constraint.

18. The system of claim 14, wherein the linear transform T₁ is a wavelet transform with the second to eight order Daubechies wavelets or symlets or coiflets of the order one to five.

19. A computer readable medium having computer executable instructions stored thereon for
receiving mixtures data X from a mixtures sensing device, wherein a recording domain of the two mixture data is defined by equation [I]:
X=AS [I]
where S is an unknown matrix of pure components and A is an unknown mixing or concentration matrix,
storing the mixture data X recorded by the mixtures sensing device,
transforming the two mixtures data X into a first new representation domain by using linear transform T₁ wherein the transformed mixtures T₁(X) are represented by equation [II]:
T₁(X)=AT₁(S) [II]
and pure components in the first new representation domain defined by equation [II] are sparser than in recording domain defined by equation [I],
estimating the number of pure components S and the mixing or concentration matrix A in the first new representation domain defined by equation [II] by means of a data clustering algorithm,
provided that the results presentation domain is the recording domain of the two mixtures data, estimating the mixing or concentration matrix A and the number of the pure components T₁(S) in the first new representation domain by means of linear programming, constrained convex programming or constrained quadratic programming,
inverse transforming the estimated pure components T₁(S) from the first new representation domain defined by equation [II] to the recording domain defined by equation [I] by applying the inverse of the transform T₁ according to equation [IV]:
S=T₁⁻¹(T₁(S)) [IV]
provided that the results presentation domain is the second new representation domain defined by equation [III], transforming the mixtures data from the recording domain defined by equation [I] to a second new representation domain by using linear transform T₂, wherein the transformed mixtures T₂(X) are represented by equation [III]:
T₂(X)=AT₂(S) [III]
and pure components in the second new representation domain defined by equation [III] are sparser than in recording domain defined by equation [I],
estimating the pure components in the second new representation domain defined by equation [III] by means of linear programming, constrained convex programming or constrained quadratic programming,
selecting the estimated pure components in accordance with the negentropy-based raking criteria, and
outputting output data including an identification of the estimated selected pure components.
